(19) United States
(12) Patent Application Publication
(10) Pub. No.: US 2018/0327646 A1
(43) Pub. Date: Nov. 15, 2018

(54) COMPOSITIONS COMPRISING 1,1,2,2-TETRAFLUOROETHANE AND USES THEREOF

(71) Applicant: THE CHEMOURS COMPANY FC, LLC, WILMINGTON, DE (US)

(72) Inventors: KONSTANTINOS KONTOMARIS, WILMINGTOIN, DE (US); MARIO JOSEPH NAPPA, LEESBURG, FL (US); TOM SPOORMAKER, PAPENDREDCHT (NL); KARL R KRAUSE, KENNETT SQUARE, PA (US); MICHAEL A SISK, HOCKESSIN, DE (US)

(21) Appl. No.: 15/569,404

(22) PCT Filed: Apr. 25, 2016
(86) PCT No.: PCT/US16/29104

§ 371 Date: Oct. 26, 2017

Related U.S. Application Data
(60) Provisional application No. 62/158,152, filed on May 7, 2015.

(51) Int. Cl. C09K 5/04

(52) U.S. Cl. CPC C09K 5/045; C09K 2205/122; C09K 2205/40; C09K 2205/126; C09K 2205/22; C09K 2205/124

(57) ABSTRACT

The present disclosure relates to compositions comprising 1,1,2,2-tetrafluoroethane and at least one additional compound selected from the group consisting of 1,1-difluoroethane, 1,2-difluoroethane, 1,1,1-trifluoroethane, difluoromethane, octafluorocyclobutane, 1,1,1,2,3,4,4,4-octafluoro-2-butene, 1,1,1,2,3,3,3-heptafluoropropane, 1,1,3,3,3-pentafluoropropene, 1,1,1,2,2-pentafluoropropane, 1,2,3,3,3-pentafluoropropene, pentafluoroethane, chlorodifluoromethane, 2-chloro-1,1,1,2-tetrafluoroethane, 1-chloro-1,1,2,2-tetrafluoroethane, methyl chloride, chlorofluoromethane, 1,2-dichloro-1,1,2,2-tetrafluoroethane, 1,1-dichloro-1,2,2,2-tetrafluoroethane, 1,1-difluoroethylene, and 1,1,2-trifluoroethylene and combinations thereof. These compositions are useful as refrigerants, heat transfer compositions, thermodynamic cycle (e.g. heating or cooling cycle) working fluids, aerosol propellants, foaming agents (blowing agents), solvents, cleaning agents, carrier fluids, displacement drying agents, buffing abrasion agents, polymerization media, foaming agents for polyolefins and polyurethane, gaseous dielectrics, power cycle working fluids, extinguishing agents, and fire suppression agents in liquid or gaseous form.

### FIELD OF THE INVENTION

The present disclosure relates to the field of compositions which may be useful as refrigerants, heat transfer compositions, thermodynamic cycle (e.g. heating or cooling cycle) working fluids, aerosol propellants, foaming agents (blowing agents), solvents, cleaning agents, carrier fluids, displacement drying agents, buffing abrasion agents, polymerization media, foaming agents for polyolefins and polyurethane, gaseous dielectrics, power cycle working fluids, extinguishing agents, and fire suppression agents in liquid or gaseous form.

### BACKGROUND OF THE INVENTION

New environmental regulations have led to the need for new compositions for use in refrigeration, air-conditioning, heat pump and power cycle apparatus and many other areas of use. Low global warming potential compounds are of particular interest.

### SUMMARY OF THE INVENTION

Applicants have found that in preparing certain lower global warming potential compounds, such as 1,1,2,2-tetrafluoroethane, that certain additional compounds are present.

Therefore, in accordance with the present invention, there is provided a composition comprising 1,1,2,2-tetrafluoroethane and at least one additional compound selected from the group consisting of 1,1-difluoroethane, 1,2-difluoroethane, 1,1,1-trifluoroethane, difluoromethane, octafluorocyclobutane, 1,1,1,2,3,4,4,4-octafluoro-2-butene, 1,1,1,2,3,3,3-heptafluoropropane, 1,1,3,3,3-pentafluoropropene, 1,1,1,2,2-pentafluoropropane, 1,2,3,3,3-pentafluoropropene, pentafluoroethane, chlorodifluoromethane, 2-chloro-1,1,1,2-tetrafluoroethane, 1-chloro-1,1,2,2-tetrafluoroethane, methyl chloride, chlorofluoromethane, 1,2-dichloro-1,1,2,2-tetrafluoroethane, 1,1-dichloro-1,2,2,2-tetrafluoroethane, 1,1-difluoroethylene, 1,1,2-trifluoroethylene, and propane and combinations thereof. The composition may contain less than about 1 weight percent of the at least one additional compound, based on the total weight of the composition.

These compositions are useful as refrigerants, heat transfer compositions, thermodynamic cycle (e.g. heating or cooling cycle) working fluids, aerosol propellants, foaming agents (blowing agents), solvents, cleaning agents, carrier fluids, displacement drying agents, buffing abrasion agents, polymerization media, foaming agents for polyolefins and polyurethane, gaseous dielectrics, power cycle working fluids, extinguishing agents, and fire suppression agents in liquid or gaseous form.

While these compositions may be useful in many applications, compositions comprising 1,1,2,2-tetrafluoroethane are particularly useful in chillers, high temperature heat pumps, and power cycles, including organic Rankine cycles.

### BRIEF DESCRIPTION OF THE DRAWINGS

FIG. 1 is a plot of the condenser pressure (Pcond) for blends of HFC-134 and HFC-152a vs. the mass fraction of HFC-152a in the blend for high temperature heat pump conditions.

FIG. 2 is a plot of the coefficient of performance (COPh) for blends of HFC-134 and HFC-152a vs. the mass fraction of HFC-152a in the blend for high temperature heat pump conditions.

FIG. 3 is a plot of the volumetric heating capacity (CAPh) for blends of HFC-134 and HFC-152a vs. the mass fraction of HFC-152a in the blend for high temperature heat pump conditions.

FIG. 4 is a plot of the coefficient of performance (COPc) for blends of HFC-134 and HFC-152a vs. the mass fraction of HFC-152a in the blend for chiller conditions.

FIG. 5 is a plot of volumetric cooling capacity (CAPc) for blends of HFC-134 and HFC-152a vs. the mass fraction of HFC-152a in the blend for chiller conditions.

### DETAILED DESCRIPTION

### Compositions

1,1,2,2-Tetrafluoroethane (HFC-134, CHF₂CHF₂) has been suggested for use as a refrigerant, heat transfer fluid, foam expansion agent, power cycle working fluid, among other uses. It has also, advantageously, been found that HFC-134 has a lower global warming potential (GWP) than HFC-134a (1,1,1,2-tetrafluoroethane) as reported IPCC Fourth Assessment Report, GWP for HFC-134 being 1100 compared to 1430 for HFC-134a. Thus, HFC-134 provides a candidate for replacing some of the higher GWP saturated CFC (chlorofluorocarbon), HCFC (hydrochlorofluorocarbon), or HFC (hydrofluorocarbon) refrigerants.

HFC-134 may be made by the hydrodehydrochlorination of 1,2-dichloro-1,1,2,2-tetrafluoroethane (i.e., CCIF₂CCIF₂ or CFC-114) to 1,1,2,2-tetrafluoroethane. Alternatively, HFC-134 may be made by catalytic hydrogenation of tetrafluoroethylene (TFE), wherein catalyst may be any that are effective at producing the desired product, including but not limited to palladium and platinum among others.

In one embodiment, the present disclosure provides a composition comprising HFC-134 and at least one compounds selected from the group consisting of hydrofluorocarbons, hydrochlorofluorocarbons, chlorofluorocarbons, perfluorocarbons, perfluoroolefins, hydrofluoroolefins, hydrochlorofluoroolefins, hydrochlorocarbons, hydrocarbons and combinations thereof.

In one embodiment, the present disclosure provides a composition comprising HFC-134 and at least one additional compound selected from the group consisting of 1,1-difluoroethane (HFC-152a), 1,2-difluoroethane (HFC-152), 1,1,1-trifluoroethane (HFC-143a), difluoromethane (HFC-32), octafluorocyclobutane (FC-C318), 1,1,1,2,3,4,4,4-octafluoro-2-butene (FO-1318my), 1,1,1,2,3,3,3-heptafluoropropane (HFC-227ea), 1,1,3,3,3-pentafluoropropene (HFO-1225zc), 1,1,1,2,2-pentafluoropropane (HFC-245cb), 1,2,3,3,3-pentafluoropropene (HFO-1225ye), pentafluoroethane (HFC-125), chlorodifluoromethane (HCFC-22), 2-chloro-1,1,1,2-tetrafluoroethane (HCFC-124), 1-chloro-1,1,2,2-tetrafluoroethane, (HCFC-124a), methyl chloride (HCC-40), chlorofluoromethane (HCFC-31), 1,2-dichloro-1,1,2,2-tetrafluoroethane (CFC-114), 1,1-dichloro-1,2,2,2-tetrafluoroethane (CFC-114a), difluoroethylene, 1,1,2-trifluoroethylene (HFO-1123), propane, and combinations thereof.

The composition of the present invention may further comprise at least one compound selected from the group consisting of 1,3,3,3-tetrafluoropropene (HFO-1234ze), 1,1,2-trifluoroethane (HFC-143), 1,1,1,2-tetrafluoroethane (HFC-134a), 1,1,1,2,2,3,3-heptafluoropropane (HFC-227ca) and fluoroethane (HFC-161).

In another embodiment, the composition of the present invention may further comprise at least one tracer compound selected from the group consisting of 1,3,3,3-tetrafluoropropene (HFO-1234ze), 1,1,2-trifluoroethane (HFC-143), 1,1,1,2-tetrafluoroethane (HFC-134a), 1,1,1,2,2,3,3-heptafluoropropane (HFC-227ca) and fluoroethane (HFC-161).

HFC-152a, HFC-143a, HFC-32, FC-C318, FO-1318my, HFC-227ea, HFO-1225zc, HFC-245cb, HFO-1225ye, HFC-125, HCFC-22, HCFC-124, HCFC-124a, HCC-40, HCFC-31, CFC-114, CFC-114a, HFO-1132a, HFO-1123, HFO-1234ze, HFC-143, HFC-227ca, HFC-161, and propane are available commercially or made by processes known in the art. The remaining additional compounds or tracers may be purchased from a specialty fluorochemical supplier, such as SynQuest Laboratories, Inc. (Alachua, Fla., USA)

The compositions of the present invention may comprise HFC-134 and one additional compound, or two additional compounds, or three or more additional compounds.

In one embodiment, the total amount of additional compound(s) in the composition comprising HFC-134 ranges from greater than zero weight percent to less than 50 weight percent, based on the total weight of the composition. In another embodiment, the total amount of additional compound(s) ranges from greater than zero weight percent to less than 25 weight percent, based on the total weight of the composition. In another embodiment, the total amount of additional compound(s) ranges from greater than zero weight percent to less than 10 weight percent, based on the total weight of the composition. In another embodiment, the total amount of additional compound(s) ranges from greater than zero weight percent to less than 5 weight percent, based on the total weight of the composition. In another embodiment, the total amount of additional compound(s) ranges from greater than zero weight percent to less than 1.0 weight percent, based on the total weight of the composition. In another embodiment, the total amount of additional compound(s) ranges from greater than zero weight percent to less than 0.5 weight percent, based on the total weight of the composition. In another embodiment, the total amount of additional compound(s) ranges from 0.0001 weight percent to about 1 weight percent. In another embodiment, the total amount of additional compound(s) ranges from 0.001 weight percent to about 1 weight percent. In another embodiment, the total amount of additional compound(s) ranges from 0.0001 weight percent to about 0.5 weight percent. In another embodiment, the total amount of additional compound(s) ranges from 0.001 weight percent to about 0.5 weight percent.

In one embodiment, the compositions comprising HFC-134 and other compounds may further comprise at least one tracer compound. The inclusion of tracer compounds is useful to determine the occurrence of dilution, adulteration or contamination; or to verify the source of the composition. The tracer compound(s) may be selected from the group consisting of 1,3,3,3-tetrafluoropropene (HFO-1234ze), 1,1,2-trifluoroethane (HFC-143), 1,1,1,2-tetrafluoroethane (HFC-134a), 1,1,1,2,2,3,3-heptafluoropropane (HFC-227ca), fluoroethane (HFC-161), or combinations thereof. In one embodiment, the tracer compound(s) may be present at a concentration from about 1 part per million (ppm) to about 1000 ppm in the composition. In another embodiment, the tracer compound(s) may be present at a concentration from about 1 ppm to about 500 ppm. In another embodiment, the tracer compound(s) may be present at a concentration from about 10 ppm to about 500 ppm. Alternatively, the tracer compound(s) may be present at a concentration from about 10 ppm to about 300 ppm.

In another embodiment, the compositions of the present invention comprise a composition selected from the group consisting of:

HFC-134 and HFC-152a;

HFC-134, HFC-152a, and HFO-1234ze;

HFC-134, HFC-152a, and HFO-1225ye;

HFC-134, HFC-152a, and HFO-1225zc;

HFC-134, HFC-152a, and HCFC-124;

HFC-134, HFC-152a, and HCFC-124a;

HFC-134, HFC-152a, and HCFC-31;

HFC-134, HFC-161, and HFO-1234ze;

HFC-134, HFC-161, and HFO-1225ye;

HFC-134, HFC-161, and HFO-1225zc;

HFC-134, HFC-161, and HCFC-124;

HFC-134, HFC-161, and HCFC-124a;

HFC-134, HFC-161, and HCFC-31;

HFC-134, HCFC-31, and HFO-1234ze;

HFC-134, HCFC-31, and HFO-1225ye;

HFC-134, HCFC-31, and HFO-1225zc;

HFC-134, HCFC-31, and HCFC-124;

HFC-134, HCFC-31, and HCFC-124a;

HFC-134, HCFC-124a, and HCFC-124;

HFC-134, HCFC-124a, and HFO-1234ze;

HFC-134, HCFC-124a, and HFO-1225ye;

HFC-134, HCFC-124a, and HFO-1225zc;

HFC-134, HCFC-124, and HFO-1234ze;

HFC-134, HCFC-124, and HFO-1225ye;

HFC-134, HCFC-124, and HFO-1225zc;

HFC-134, HFC-152a, HFC-134a, and HFO-1225ye;

HFC-134, HFC-152a, HFC-134a, and HFO-1225zc;

HFC-134, HFC-152a, HFO-1225zc, and HFO-1225ye;

HFC-134, HFC-134a, HFO-1225zc, and HFO-1225ye; and

HFC-134, HFC-134a, HFC-152a, and HFO-1234ze.

In one embodiment of the compositions disclosed herein HFO-1234ze is E-HFO-1234ze, Z-HFO-1234ze or combinations thereof.

In one embodiment of the compositions disclosed herein HFO-1225ye is E-HFO-1225ye, Z-HFO-1225ye, or combinations thereof.

In one embodiment of the compositions disclosed herein difluoroethylene is 1,1-difluoroethylene (HFO-1132a), 1,2-difluoroethylene (HFO-1132) or combinations thereof. Additionally, in another embodiment HFO-1132 is E-HFO-1132, Z-HFO-1132 or combinations thereof.

Thus, in another embodiment the compositions of the present invention comprise a composition selected from the group consisting of:

HFC-134, HFC-152a, and Z-HFO-1234ze;

HFC-134, HFC-152a, and E-HFO-1234ze;

HFC-134, HFC-152a, and Z-HFO-1225ye;

HFC-134, HFC-152a, and E-HFO-1225ye;

HFC-134, HFC-161, and Z-HFO-1234ze;

HFC-134, HFC-161, and E-HFO-1234ze;

HFC-134, HFC-161, and Z-HFO-1225ye;

HFC-134, HFC-161, and E-HFO-1225ye;

HFC-134, HCFC-31, and Z-HFO-1234ze;

HFC-134, HCFC-31, and E-HFO-1234ze;

HFC-134, HCFC-31, and Z-HFO-1225ye;

HFC-134, HCFC-31, and E-HFO-1225ye;

HFC-134, HCFC-124a, and Z-HFO-1234ze;

HFC-134, HCFC-124a, and E-HFO-1234ze;

HFC-134, HCFC-124a, and Z-HFO-1225ye;

HFC-134, HCFC-124a, and E-HFO-1225ye;

HFC-134, HCFC-124, and Z-HFO-1234ze;

HFC-134, HCFC-124, and E-HFO-1234ze;

HFC-134, HCFC-124, and Z-HFO-1225ye;

HFC-134, HCFC-124, and E-HFO-1225ye; and

HFC-134, HFC-134a, HFC-152a, and E-HFO-1234ze.

In one embodiment, the compositions comprise from about 1 to about 99 weight percent HFC-134 and from about 99 to about 1 weight percent HFC-152a. In another embodiment, the compositions comprise from about 10 to about 90 weight percent HFC-134 and from about 90 to about 10 weight percent HFC-152a. In another embodiment, the compositions comprise from about 20 to about 80 weight percent HFC-134 and from about 80 to about 20 weight percent HFC-152a. In another embodiment, the compositions comprise from about 30 to about 80 weight percent HFC-134 and from about 70 to about 20 weight percent HFC-152a. In another embodiment, the compositions comprise from about 55 to about 99 weight percent HFC-134 and from about 45 to about 1 weight percent HFC-152a. In another embodiment, the compositions comprise from about 55 to about 92 weight percent HFC-134 and from about 45 to about 8 weight percent HFC-152a. In another embodiment, the compositions comprise from about 87 to about 99 weight percent HFC-134 and from about 13 to about 1 weight percent HFC-152a, or from about 90 to about 99 weight percent HFC-134 and from about 10 to about 1 weight percent HFC-152a which are expected to be non-flammable. In another embodiment, the compositions comprise from about 55 to about 87 weight percent HFC-134 and from about 45 to about 13 weight percent HFC-152a or from about 70 to about 90 weight percent HFC-134 and from about 30 to about 10 weight percent HFC-152a, which are expected to be classified by the American Society of Heating, Refrigeration and Air-conditioning Engineers (ASHRAE) as 2 L flammable.

In another embodiment, the compositions comprise from about 20 to about 75 weight percent HFC-134 and from about 80 to about 25 weight percent HFC-152a. In another embodiment, the compositions comprise from about 20 to about 50 weight percent HFC-134 and from about 80 to about 50 weight percent HFC-152a. In another embodiment, the compositions comprise from about 50 to about 75 weight percent HFC-134 and from about 50 to about 25 weight percent HFC-152a.

In one embodiment, the compositions comprise from about 1 to about 98 weight percent HFC-134, from about 1 to about 98 weight percent HFC-152a and from about 1 to about 98 weight percent E-HFO-1234ze. In one embodiment, the compositions comprise from about 10 to about 80 weight percent HFC-134, from about 10 to about 80 weight percent HFC-152a and from about 10 to about 80 weight percent E-HFO-1234ze.

In particular, compositions with utility in certain applications may be required to be non-flammable or 2 L flammable. Therefore, in another embodiment, the compositions comprise from about 6 to about 13 weight percent HFC-152a, HFC-134 and E-HFO-1234ze with a weight ratio of 37/63 based on weight percent of HFC-134/E-HFO-1234ze or with a weight ratio of 40/60 based on weight percent of HFC-134/E-HFO-1234ze, which are expected to be non-flammable. In another embodiment, the compositions comprise from about 13 to about 45 weight percent HFC-152a, HFC-134 and E-HFO-1234ze with a weight ratio of 37/63 based on weight percent of HFC-134/E-HFO-1234ze or with a weight ratio of 40/60 based on weight percent of HFC-134/E-HFO-1234ze, which are expected to be classified by ASHRAE as 2 L flammable. In another embodiment, the compositions comprise from about 6 to about 30 weight percent HFC-152a, HFC-134 and E-HFO-1234ze with a weight ratio of 37/63 based on weight percent of HFC-134/E-HFO-1234ze or with a weight ratio of 40/60 based on weight percent of HFC-134/E-HFO-1234ze, which are expected to be classified by ASHRAE as 2 L flammable.

In one embodiment, the compositions may comprise from about 1 to about 40 weight percent HFC-134; from about 12 to about 40 weight percent HFC-134; from about 15 to about 40 weight percent HFC-134; from about 24 to about 40 weight percent HFC-134; from about 24 to about 37 weight percent HFC-134; from about 27 to about 40 weight percent HFC-134; or from about 27 to about 37 weight percent HFC-134.

In one embodiment, the compositions may comprise from about 15 to about 63 weight percent E-1234ze; from about 18 to about 63 weight percent E-1234ze; from about 15 to about 60 weight percent E-1234ze; from about 18 to about 60 weight percent E-1234ze; from about 35 to about 63 weight percent E-1234ze; from about 35 to about 60 weight percent E-1234ze; from about 47 to about 63 weight percent E-1234ze; from about 47 to about 60 weight percent E-1234ze; from about 50 to about 63 weight percent E-1234ze; or from about 50 to about 60 weight percent E-1234ze.

In one embodiment, the compositions may comprise from about 6 to about 45 weight percent HFC-152a; from about 6 to about 25 weight percent HFC-152a; from about 6 to about 13 weight percent HFC-152a; from about 13 to about 45 weight percent HFC-152a; from about 13 to about 25 weight percent HFC-152a; or from about 25 to about 45 weight percent HFC-152a.

In another embodiment, the compositions may comprise from about 4 to about 33 weight percent HFC-134, from about 10 to about 90 weight percent HFC-152a, and from about 6 to about 57 weight percent E-1234ze. In another embodiment, the compositions may comprise from about 12 to about 40 weight percent HFC-134, from about 6 to about 45 weight percent HFC-152a, and from about 35 to about 63 weight percent E-1234ze. In another embodiment, the compositions may comprise from about 40 to about 45 weight percent HFC-134, from about 5 to about 15 weight percent HFC-152a, and from about 40 to about 55 weight percent E-1234ze.

In one embodiment, the compositions disclosed herein may be prepared by any convenient method to combine the desired amounts of the individual components. A preferred method is to weigh the desired component amounts and thereafter combine the components in an appropriate vessel. Agitation may be used, if desired.

### Utility

Many of the additional compounds have lower global warming potential as compared to HFC-134. Therefore adding them to HFC-134 will reduce the GWP of the resulting composition. Many applications for fluorochemicals such as HFC-134 are being regulated to require the use of lower GWP refrigerants or working fluids. The compositions as disclosed herein may provide such lower GWP compositions.

Many of the compositions of the present invention can be formulated to have GWP less than 1000. Several compositions can be formulated to have GWP less than 500.

The presence of additional compounds and/or tracer compounds in a sample of HFC-134 may also be used to identify the process by which the compound was manufactured. Thus, the additional compounds and/or tracer compounds may be used to detect infringement of chemical manufacturing patents claiming the process by which the sample may have been manufactured. Additionally, the additional compounds and/or tracer compounds may be used to identify whether product is produced by the patentee or some other entity, who may infringe product related patents.

Additional compounds and/or tracer compounds may also provide improved solubility for active ingredients in an aerosol or polymer constituents of a foam. Additionally, for refrigerant applications, such as use in air conditioning, heat pumps, refrigeration, and power cycles (e.g., organic Rankine cycles), the additional compounds may provide improved solubility with refrigeration lubricants, such as mineral oils, alkylbenzenes, synthetic paraffins, synthetic naphthenes, poly(alpha)olefins, polyol esters (POE), polyalkylene glycols (PAG), polyvinyl ethers (PVE), or perfluoropolyethers (PFPE) or mixtures thereof.

In certain embodiments, additional compounds and/or tracer compounds containing at least one chlorine atom may also provide improved solubility for active ingredients in an aerosol or polymer constituents of a foam. Additionally, for refrigerant applications, such as use in air conditioning, heat pumps, refrigeration, and power cycles (e.g., organic Rankine cycles), the additional compounds containing at least one chlorine atom may provide improved solubility with refrigeration lubricants, such as mineral oils, alkylbenzenes, synthetic paraffins, synthetic naphthenes, poly(alpha)olefins, polyol esters (POE), polyalkylene glycols (PAG), polyvinyl ethers (PVE), or perfluoropolyethers (PFPE) or mixtures thereof.

The compositions disclosed herein comprising HFC-134 are useful as lower GWP heat transfer compositions, refrigerants, power cycle working fluids, aerosol propellants, foaming agents, blowing agents, solvents, cleaning agents, carrier fluids, displacement drying agents, buffing abrasion agents, polymerization media, expansion agents for poly-olefins and polyurethane, gaseous dielectrics, fire extinguishing agents, and fire suppression agents in liquid or gaseous form. The disclosed compositions can act as a working fluid used to carry heat from a heat source to a heat sink. Such heat transfer compositions may also be useful as a refrigerant in a cycle wherein the fluid undergoes a phase change; that is, from a liquid to a gas and back or vice versa.

Vapor-compression refrigeration, air-conditioning, or heat pump systems include an evaporator, a compressor, a condenser, and an expansion device. A vapor-compression cycle re-uses refrigerant in multiple steps producing a cooling effect in one step and a heating effect in a different step. The cycle can be described simply as follows. Liquid refrigerant enters an evaporator through an expansion device, and the liquid refrigerant boils in the evaporator, by withdrawing heat from the environment, at a low temperature to form a vapor and produce cooling. The low-pressure vapor enters a compressor where the vapor is compressed to raise its pressure and temperature. The higher-pressure (compressed) vapor refrigerant then enters the condenser in which the refrigerant condenses and discharges its heat to the environment. The refrigerant returns to the expansion device through which the liquid expands from the higher-pressure level in the condenser to the low-pressure level in the evaporator, thus repeating the cycle.

In one embodiment, there is provided a heat transfer system containing any of the present compositions comprising HFC-134. In another embodiment is disclosed a refrigeration, air-conditioning or heat pump apparatus containing any of the present compositions comprising HFC-134 as disclosed herein. In another embodiment, is disclosed a stationary refrigeration or air-conditioning apparatus containing any of the present compositions comprising HFC-134 as disclosed herein. In yet another embodiment is disclosed a mobile refrigeration or air conditioning apparatus containing a composition as disclosed herein.

Examples of heat transfer systems include but are not limited to air conditioners, freezers, refrigerators, heat pumps, water chillers, flooded evaporator chillers, direct expansion chillers, walk-in coolers, heat pumps, mobile refrigerators, mobile air conditioning units and combinations thereof.

In one embodiment, the compositions comprising HFC-134 are useful in mobile heat transfer systems, including refrigeration, air conditioning, or heat pump systems or apparatus. In another embodiment, the compositions are useful in stationary heat transfer systems, including refrigeration, air conditioning, or heat pump systems or apparatus.

As used herein, mobile heat transfer systems refers to any refrigeration, air conditioner, or heating apparatus incorporated into a transportation unit for the road, rail, sea or air. In addition, mobile refrigeration or air conditioner units, include those apparatus that are independent of any moving carrier and are known as “intermodal” systems. Such intermodal systems include “containers’ (combined sea/land transport) as well as “swap bodies” (combined road/rail transport).

As used herein, stationary heat transfer systems are systems that are fixed in place during operation. A stationary heat transfer system may be associated within or attached to buildings of any variety or may be stand-alone devices located out of doors, such as a soft drink vending machine. These stationary applications may be stationary air conditioning and heat pumps (including but not limited to chillers, high temperature heat pumps, including trans-critical heat pumps (with condenser temperatures above 50° C., 55° C., 60° C., 65° C., 70° C., 80° C., 100° C., 120° C., 140° C., 160° C., 180° C., or 200° C.), residential, commercial or industrial air conditioning systems, and including window, ductless, ducted, packaged terminal, chillers, and those exterior but connected to the building such as rooftop systems). In stationary refrigeration applications, the disclosed compositions may be useful in high temperature, medium temperature and/or low temperature refrigeration equipment including commercial, industrial or residential refrigerators and freezers, ice machines, self-contained coolers and freezers, flooded evaporator chillers, direct expansion chillers, walk-in and reach-in coolers and freezers, and combination systems. In some embodiments, the disclosed compositions may be used in supermarket refrigerator systems.

Therefore in accordance with the present invention, the compositions as disclosed herein containing HFC-134 may be useful in methods for producing cooling, producing heating, and transferring heat.

In one embodiment, a method is provided for producing cooling comprising evaporating any of the present compositions comprising HFC-134 in the vicinity of a body to be cooled, and thereafter condensing said composition. In another embodiment, the method produces cooling in a chiller. In another embodiment, the chiller is a centrifugal chiller, meaning the chiller apparatus comprises a centrifugal compressor.

In another embodiment, a method is provided for producing heating comprising condensing any of the present compositions comprising HFC-134 in the vicinity of a body to be heated, and thereafter evaporating said compositions.

In one embodiment of the method for producing heating of said heating is produced in a high temperature heat pump comprising a heat exchanger operating temperature of at least 55° C. In comparison, residential heat pumps are used to produce heated air to warm a residence or home (including single family or multi-unit attached homes) and operate with maximum heat exchanger temperatures from about 30° C. to about 50° C.

In another embodiment of the method for producing heating, the heat exchanger is selected from the group consisting of a supercritical working fluid cooler and a condenser. Thus, operation of the high temperature heat pump may be in transcritical or supercritical mode when the heat exchanger is a supercritical working fluid cooler.

In another embodiment of the method for producing heating, wherein the heat exchanger operates at a temperature greater than about 71° C.

In another embodiment of the method for producing heating, the high temperature heat pump further comprises a compressor selected from a screw compressor, a scroll compressor or a centrifugal compressor. In another embodiment of the method for producing heating, the high temperature heat pump comprises a centrifugal compressor.

In another embodiment of the method for producing heating, the method further comprises passing a first heat transfer medium through the heat exchanger, whereby said extraction of heat heats the first heat transfer medium, and passing the heated first heat transfer medium from the heat exchanger to the body to be heated.

In another embodiment of the method for producing heating, the first heat transfer medium is an industrial heat transfer liquid and the body to be heated is a chemical process stream. In another embodiment of the method for producing heating, the first heat transfer medium is water and the body to be heated is air for space heating.

In another embodiment of the method for producing heating, the method further comprises expanding the cooled working fluid and then heating the working fluid in a second heat exchanger to produce a heated working fluid. In another embodiment of the method for producing heating, said second heat exchanger is an evaporator and the heated working fluid is a vapor.

In one embodiment of the method for producing heating in a high temperature heat pump, heat is exchanged between at least two stages arranged in a cascade configuration, comprising absorbing heat at a selected lower temperature in a first working fluid in a first cascade stage and transferring this heat to a second working fluid of a second cascade stage that supplies heat at a higher temperature; wherein the first or second working fluid comprises a refrigerant consisting of 1,1,2,2-tetrafluoroethane.

In one embodiment of the present invention, a method for raising the condenser operating temperature in a high temperature heat pump apparatus is provided. The method comprises charging the high temperature heat pump with a working fluid comprising a refrigerant comprising 1,1,2,2-tetrafluoroethane (HFC-134) as disclosed herein. In another embodiment of the method, said high temperature heat pump apparatus comprises a centrifugal compressor. In another embodiment of the method, the condenser operating temperature is raised to a temperature greater than about 71° C.

In one embodiment of the present invention, a high temperature heat pump apparatus is provided. The high temperature heat pump apparatus contains a working fluid comprising a refrigerant comprising a composition of 1,1,2,2-tetrafluoroethane as disclosed herein. In another embodiment of the apparatus, said apparatus comprises a centrifugal compressor. In another embodiment of the apparatus, the apparatus comprises a condenser, wherein the condenser operates at a temperature greater than about 71° C.

In another embodiment of the high temperature heat pump apparatus, the apparatus comprises (a) a first heat exchanger through which a working fluid flows and is heated; (b) a compressor in fluid communication with the first heat exchanger that compresses the heated working fluid to a higher pressure; (c) a second heat exchanger in fluid communication with the compressor through which the high pressure working fluid flows and is cooled; and (d) a pressure reduction device in fluid communication with the second heat exchanger wherein the pressure of the cooled working fluid is reduced and said pressure reduction device further being in fluid communication with the first heat exchanger such that the working fluid then repeats flow through components (a), (b), (c) and (d) in a repeating cycle.

In another embodiment of the high temperature heat pump apparatus, the apparatus further comprises a compressor selected from a screw compressor, a scroll compressor or a centrifugal compressor. In another embodiment of the method for producing heating, the high temperature heat pump comprises a centrifugal compressor. In another embodiment of the apparatus, the high temperature heat pump apparatus has at least two heating stages.

In another embodiment of the apparatus, the high temperature heat pump apparatus comprises a first stage and a final stage, and optionally, at least one intermediate stage, arranged as a cascade heating system, each stage circulating a working fluid therethrough, wherein heat is transferred to the final stage from the first stage or an intermediate stage and wherein the working fluid in at least one stage comprises a refrigerant comprising 1,1,2,2-tetrafluoroethane as disclosed herein.

In another embodiment of the apparatus, the high temperature heat pump apparatus has at least two heating stages, a first stage and a final stage, arranged as a cascade heating system, each stage circulating a working fluid therethrough comprising:
(a) a first expansion device for reducing the pressure and temperature of a first working fluid liquid;
(b) an evaporator in fluid communication with the first expansion device having an inlet and an outlet;
(c) a first compressor in fluid communication with the evaporator and having an inlet and an outlet;
(d) a cascade heat exchanger system in fluid communication with the first compressor outlet having:
   (i) a first inlet and a first outlet, through which flows the first working fluid and
   (ii) a second inlet and a second outlet through which flows a second working fluid in thermal communication with the first working fluid;
(e) a second compressor in fluid communication with the second outlet of the cascade heat exchanger system and having an inlet and an outlet;
(f) a condenser in fluid communication with the second compressor and having an inlet and an outlet; and
(g) a second expansion device in fluid communication with the condenser;
   wherein the first or second working fluid comprises a refrigerant comprising 1,1,2,2-tetrafluoroethane as disclosed herein.

In another embodiment of the cascade high temperature heat pump apparatus, the first working fluid comprises at least one refrigerant selected from the group consisting of HFO-1234yf, E-HFO-1234ze, HFO-1243zf, HFC-161, HFC-32, HFC-125, HFC-245cb, HFC-134a, HFC-143a, HFC-152a, HFC-227ea, and mixtures thereof; and wherein the second working fluid comprises a refrigerant comprising HFC-134 and at least one additional compound as disclosed herein. Of note are apparatus wherein the second working fluid comprises HFC-134 and HFC-152a, or HFC-134, HFC-152a, and E-HFO-1234ze.

In another embodiment of the cascade high temperature heat pump apparatus, the second working fluid comprises at least one refrigerant selected from the group consisting of HFC-236ea, HFC-236fa, HFC-245fa, HFC-245eb, E-HFO-1234ye, Z-HFO-1234ye, Z-HFO-1234ze, HFC-365mfc, HFC-4310mee, HFO-1336mzz-E, HFO-1336mzz-Z, HFO-1438mzz-E, HFO-1438mzz-Z, HFO-1438ezy-E, HFO-1438ezy-Z, HFO-1336yf, HFO-1336ze-E, HFO-1336ze-Z, HCFO-1233zd-E, HCFO-1233zd-Z, HCFO-1233xf, HFE-347mcc, HFE-449mccc, HFE-569mccc, 3-ethoxy-1,1,1,2,3,4,4,5,5,6,6,6-dodecafluoro-2-trifluoromethyl-hexane, 1,1,1,2,2,4,5,5,5-nonafluoro-4-(trifluoromethyl)-3-pentanone, octamethylcyclotetrasiloxane, decamethylcyclopentasiloxane, octamethyltrisiloxane, hexamethyldisiloxane, n-pentane, isopentane, cyclopentane, hexanes, cyclohexane, heptanes, toluene and mixtures thereof; and the first working fluid comprises a refrigerant comprising HFC-134 and at least one additional compound as disclosed herein. Of note are apparatus wherein the second working fluid comprises HFC-134 and HFC-152a, or HFC-134, HFC-152a, and E-HFO-1234ze.

In another embodiment of the cascade high temperature heat pump apparatus, the working fluid in the final stage comprises at least one refrigerant selected from the group consisting of HFC-236ea, HFC-236fa, HFC-245fa, E-HFO-1234ye, Z-HFO-1234ye, Z-HFO-1234ze, HFC-245eb, HFC-365mfc, HFC-4310mee, HFO-1336mzz-E, HFO-1336mzz-Z, HFO-1438mzz-E, HFO-1438mzz-Z, HFO-1438ezy-E, HFO-1438ezy-Z, HFO-1336yf, HFO-1336ze-E, HFO-1336ze-Z, HCFO-1233zd-E, HCFO-1233zd-Z, HCFO-1233xf, HFE-347mcc, HFE-449mccc, HFE-569mccc, 3-ethoxy-1,1,1,2,3,4,4,5,5,6,6,6-dodecafluoro-2-trifluoromethyl-hexane, 1,1,1,2,2,4,5,5,5-nonafluoro-4-(trifluoromethyl)-3-pentanone, octamethylcyclotetrasiloxane, decamethylcyclopentasiloxane, octamethyltrisiloxane, hexamethyldisiloxane, n-pentane, isopentane, cyclopentane, hexanes, cyclohexane, heptanes, toluene and mixtures thereof.

In another embodiment of the cascade high temperature heat pump apparatus, the first working fluid comprises at least one working fluid selected from CO₂, NH₃, or N₂O.

In one embodiment of the present invention use of a refrigerant comprising HFC-134 and at least one additional compound as working fluid in a high temperature heat pump is provided. In another embodiment of the use in a high temperature heat pump, the high temperature heat pump comprises a compressor selected from a screw compressor, a scroll compressor or a centrifugal compressor. In another embodiment of the use, the high temperature heat pump comprises a centrifugal compressor. In another embodiment of the apparatus, the high temperature heat pump apparatus has at least two heating stages. In another embodiment of the use, the high temperature heat pump further comprises a condenser. In another embodiment of the use, the condenser operating temperature is greater than about 71° C.

In one embodiment of the present invention, a method for replacing HFC-134a in a high temperature heat pump is provided. The method comprises charging said high temperature heat pump with a working fluid comprising a refrigerant comprising HFC-134 and at least one additional compound as disclosed herein. In another embodiment of the method to replace HFC-134a, said high temperature heat pump comprises a centrifugal compressor. In another embodiment of the method for replacing HFC-134a, said high temperature heat pump further comprises a condenser. In another embodiment, the condenser operating temperature is raised to a temperature greater than about 71° C. In another embodiment, the condenser operating temperature is raised to a temperature from about 71° C. to about 80° C.

In another embodiment, disclosed is a method of using the present compositions comprising HFC-134 as a heat transfer fluid composition. The method comprises transporting said composition from a heat source to a heat sink.

The compositions disclosed herein may be useful as low global warming potential (GWP) replacements for other currently used refrigerants, including but not limited to R-245fa (or HFC-245fa, 1,1,1,3,3-pentafluoropropane), R-114 (or CFC-114, 1,2-dichloro-1,1,2,2-tetrafluoroethane), R-236fa (or HFC-236fa, 1,1,1,3,3,3-hexafluoropropane), R-236ea (or HFC-236ea, 1,1,1,2,3,3-hexafluoropropane), R-124 (or HCFC-124, 2-chloro-1,1,1,2-tetrafluoroethane), and R-134a (or HFC-134a, 1,1,1,2-tetrafluoroethane) among others.

In many applications, some embodiments of the present compositions comprising HFC-134 are useful as refrigerants and provide at least comparable cooling performance (meaning cooling capacity and energy efficiency) as the refrigerant for which a replacement is being sought. Additionally, the compositions of the present invention provide heating performance (meaning heating capacity and energy efficiency) comparable to a refrigerant being replaced.

In another embodiment is provided a method for recharging a heat transfer system that contains a refrigerant to be replaced and a lubricant, said method comprising removing the refrigerant to be replaced from the heat transfer system while retaining a substantial portion of the lubricant in said system and introducing one of the present compositions comprising HFC-134 to the heat transfer system. In some embodiments, the lubricant in the system is partially replaced (e.g. replace a portion of the mineral oil lubricant used with for instance, HCFC-22 with a POE lubricant).

In another embodiment, the compositions of the present invention comprising HFC-134 may be used to top-off a refrigerant charge in a chiller. For instance, if a chiller or heat pump using HFC-134a has diminished performance due to leakage of refrigerant, the compositions as disclosed herein may be added to bring performance back up to specification.

In another embodiment, a heat exchange system containing any of the present compositions comprising HFC-134 is provided, wherein said system is selected from the group consisting of air conditioners, freezers, refrigerators, heat pumps, water chillers, flooded evaporator chillers, direct expansion chillers, walk-in coolers, heat pumps, mobile refrigerators, mobile air conditioning units, and systems having combinations thereof. Additionally, the compositions comprising HFC-134 as disclosed herein may be useful in secondary loop systems wherein these compositions serve as the primary refrigerant thus providing cooling to a secondary heat transfer fluid that thereby cools a remote location.

In another embodiment, the present invention relates to foam expansion agent compositions comprising HFC-134 for use in preparing foams. In other embodiments the invention provides foamable compositions, and preferably thermoset (like polyurethane, polyisocyanurate, or phenolic) foam compositions, and thermoplastic (like polystyrene, polyethylene, or polypropylene) foam compositions and method of preparing foams. In such foam embodiments, one or more of the present compositions comprising HFC-134 are included as a foam expansion agent in foamable compositions, which composition preferably includes one or more additional components capable of reacting and/or mixing and foaming under the proper conditions to form a foam or cellular structure.

The present invention further relates to a method of forming a foam comprising: (a) adding to a foamable composition a composition comprising HFC-134 of the present invention; and (b) processing the foamable composition under conditions effective to form a foam.

Another embodiment of the present invention relates to the use of the compositions of the present invention comprising HFC-134 as propellants in sprayable compositions. Additionally, the present invention relates to a sprayable compositions comprising HFC-134. The active ingredient to be sprayed together with inert ingredients, solvents and other materials may also be present in a sprayable composition. In one embodiment, a sprayable composition is an aerosol. The present compositions can be used to formulate a variety of industrial aerosols or other sprayable compositions such as contact cleaners, dusters, lubricant sprays, mold release sprays, insecticides, and the like, and consumer aerosols such as personal care products (such as, e.g., hair sprays, deodorants, and perfumes), household products (such as, e.g., waxes, polishes, pan sprays, room fresheners, and household insecticides), and automotive products (such as, e.g., cleaners and polishers), as well as medicinal materials such as anti-asthma and anti-halitosis medications. Examples of this includes metered dose inhalers (MDIs) for the treatment of asthma and other chronic obstructive pulmonary diseases and for delivery of medicaments to accessible mucous membranes or intra-nasally

The present invention further relates to a process for producing aerosol products comprising the step of adding a composition of the present invention comprising HFC-134 to a formulation, including active, ingredients in an aerosol container, wherein said composition functions as a propellant. Additionally, the present invention further relates to a process for producing aerosol products comprising the step of adding a composition of the present invention comprising HFC-134 to a barrier type aerosol package (like a bag-in-a-can or piston can) wherein said composition is kept separated from other formulation ingredients in an aerosol container, and wherein said composition functions as a propellant. Additionally, the present invention further relates to a process for producing aerosol products comprising the step of adding only a composition of the present invention comprising HFC-134 to an aerosol package, wherein said composition functions as the active ingredient (e.g., a duster, or a cooling or freezing spray).

A process for converting heat from a heat source to mechanical energy is provided. The process comprises heating a working fluid comprising HFC-134 and at least one additional compound, and optionally at least one tracer compound and thereafter expanding the heated working fluid. In the process, heating of the working fluid uses heat supplied from the heat source; and expanding of the heated working fluid generates mechanical energy as the pressure of the working fluid is lowered.

The process for converting heat may be a subcritical cycle, a trans-critical cycle or a supercritical cycle. In a trans-critical cycle, the working fluid is compressed to a pressure above its critical pressure prior to being heated, and then during expansion the working fluid pressure is reduced to below its critical pressure. In a super critical cycle, the working fluid remains above its critical pressure for the complete cycle (e.g., compression, heating, expansion and cooling).

Heat sources include low pressure steam, industrial waste heat, solar energy, geothermal hot water, low-pressure geothermal steam (primary or secondary arrangements), or distributed power generation equipment utilizing fuel cells or prime movers such as turbines, microturbines, or internal combustion engines. One source of low-pressure steam could be the process known as a binary geothermal Rankine cycle. Large quantities of low-pressure steam can be found in numerous locations, such as in fossil fuel powered electrical generating power plants. Other sources of heat include waste heat recovered from gases exhausted from mobile internal combustion engines (e.g. truck or rail diesel engines or ships), waste heat from exhaust gases from stationary internal combustion engines (e.g. stationary diesel engine power generators), waste heat from fuel cells, heat available at combined heating, cooling and power or district heating and cooling plants, waste heat from biomass fueled engines, heat from natural gas or methane gas burners or methane-fired boilers or methane fuel cells (e.g. at distributed power generation facilities) operated with methane from various sources including biogas, landfill gas and coal-bed methane, heat from combustion of bark and lignin at paper/pulp mills, heat from incinerators, heat from low pressure steam at conventional steam power plants (to drive “bottoming” Rankine cycles), and geothermal heat.

The process of this invention is typically used in an organic Rankine power cycle. Heat available at relatively low temperatures compared to steam (inorganic) power cycles can be used to generate mechanical power through Rankine cycles using working fluids as described herein. In the process of this invention, working fluid is compressed prior to being heated. Compression may be provided by a pump which pumps working fluid to a heat transfer unit (e.g., a heat exchanger or an evaporator) where heat from the heat source is used to heat the working fluid. The heated working fluid is then expanded, lowering its pressure. Mechanical energy is generated during the working fluid expansion using an expander. Examples of expanders include turbo or dynamic expanders, such as turbines, and positive displacement expanders, such as screw expanders, scroll expanders, and piston expanders. Examples of expanders also include rotary vane expanders.

Mechanical power can be used directly (e.g. to drive a compressor) or be converted to electrical power through the use of electrical power generators. In a power cycle where the working fluid is re-used, the expanded working fluid is cooled. Cooling may be accomplished in a working fluid cooling unit (e.g. a heat exchanger or a condenser). The cooled working fluid can then be used for repeated cycles (i.e., compression, heating, expansion, etc.). The same pump used for compression may be used for transferring the working fluid from the cooling stage.

Of particular utility as a working fluid for chillers, high temperature heat pumps and organic Rankine cycle systems are compositions containing HFC-134 and HFC-152a. In one embodiment, the compositions comprise from about 1 to about 99 weight percent HFC-134 and from about 99 to about 1 weight percent HFC-152a. In another embodiment, the compositions comprise from about 10 to about 90 weight percent HFC-134 and from about 90 to about 10 weight percent HFC-152a. In another embodiment, the compositions comprise from about 20 to about 80 weight percent HFC-134 and from about 80 to about 20 weight percent HFC-152a. In another embodiment, the compositions comprise from about 30 to about 80 weight percent HFC-134 and from about 70 to about 20 weight percent HFC-152a. In another embodiment, the compositions comprise from about 55 to about 99 weight percent HFC-134 and from about 45 to about 1 weight percent HFC-152a. In another embodiment, the compositions comprise from about 55 to about 92 weight percent HFC-134 and from about 45 to about 8 weight percent HFC-152a. In another embodiment, the compositions comprise from about 87 to about 99 weight percent HFC-134 and from about 13 to about 1 weight percent HFC-152a, or from about 90 to about 99 weight percent HFC-134 and from about 10 to about 1 weight percent HFC-152a which are expected to be non-flammable. In another embodiment, the compositions comprise from about 55 to about 87 weight percent HFC-134 and from about 45 to about 13 weight percent HFC-152a or from about 70 to about 90 weight percent HFC-134 and from about 30 to about 10 weight percent HFC-152a, which are expected to be classified by the American Society of Heating, Refrigeration and Air-conditioning Engineers (ASHRAE) as 2 L flammable.

Compositions containing HFC-134 and HFC-152a from about 6-45 wt % HFC-152a provide maximum capacity and COP with glide lower than about 0.15 K and tip speed match to HFC-134a within about 15% under typical conditions for chiller operation. Surprisingly, the addition of HFC-152a to HFC-134 increases both COP and capacity, usually a trade-off between COP and capacity is observed with one decreasing as the other increases and vice versa.

Addition of HFC-152a to HFC-134 improves performance in terms of COP (COPh is coefficient of performance for heating, a measure of energy efficiency) and Capacity (CAPh is the volumetric heating capacity for the working fluid). And also reduces GWP, which may be desired depending on regional/country specific regulations. Even with 40 wt % HFC-152a present the temperature glide is a minimum value of 0.05/0.06 K.

Surprisingly, the addition of HFC-152a to HFC-134 increases both COP and capacity, up to about 40% of HFC-152a in heating applications.

Also, of particular utility as a working fluid for chillers, high temperature heat pumps and organic Rankine cycle systems are compositions containing HFC-134, HFC-152a and E-HFO-1234ze. In one embodiment, the compositions comprise from about 1 to about 98 weight percent HFC-134, from about 1 to about 98 weight percent HFC-152a and from about 1 to about 98 weight percent E-HFO-1234ze. In one embodiment, the compositions comprise from about 10 to about 80 weight percent HFC-134, from about 10 to about 80 weight percent HFC-152a and from about 10 to about 80 weight percent E-HFO-1234ze.

In particular, compositions with utility as a working fluid for chillers, high temperature heat pumps and organic Rankine cycle systems may be required to be non-flammable or at least only 2 L flammable. Therefore, in another embodiment, the compositions comprise from about 6 to about 13 weight percent HFC-152a, HFC-134 and E-HFO-1234ze with a weight ratio of 37/63 based on weight percent of HFC-134/E-HFO-1234ze or with a weight ratio of 40/60 based on weight percent of HFC-134/E-HFO-1234ze, which are expected to be non-flammable. In another embodiment, the compositions comprise from about 13 to about 45 weight percent HFC-152a, HFC-134 and E-HFO-1234ze with a weight ratio of 37/63 based on weight percent of HFC-134/E-HFO-1234ze or with a weight ratio of 40/60 based on weight percent of HFC-134/E-HFO-1234ze, which are expected to be classified by ASHRAE as 2 L flammable. In another embodiment, the compositions comprise from about 6 to about 30 weight percent HFC-152a, HFC-134 and E-HFO-1234ze with a weight ratio of 37/63 based on weight percent of HFC-134/E-HFO-1234ze or with a weight ratio of 40/60 based on weight percent of HFC-134/E-HFO-1234ze, which are expected to be classified by ASHRAE as 2 L flammable.

In one embodiment, the compositions with utility as a working fluid for chillers, high temperature heat pumps and organic Rankine cycle systems may comprise from about 1 to about 40 weight percent HFC-134; from about 12 to about 40 weight percent HFC-134; from about 15 to about 40 weight percent HFC-134; from about 24 to about 40 weight percent HFC-134; from about 24 to about 37 weight percent HFC-134; from about 27 to about 40 weight percent HFC-134; or from about 27 to about 37 weight percent HFC-134.

In one embodiment, the compositions with utility as a working fluid for chillers, high temperature heat pumps and organic Rankine cycle systems may comprise from about 15 to about 63 weight percent E-1234ze; from about 18 to about 63 weight percent E-1234ze; from about 15 to about 60 weight percent E-1234ze; from about 18 to about 60 weight percent E-1234ze; from about 35 to about 63 weight percent E-1234ze; from about 35 to about 60 weight percent E-1234ze; from about 47 to about 63 weight percent E-1234ze; from about 47 to about 60 weight percent E-1234ze; from about 50 to about 63 weight percent E-1234ze; or from about 50 to about 60 weight percent E-1234ze.

In one embodiment, the compositions with utility as a working fluid for chillers, high temperature heat pumps and organic Rankine cycle systems may comprise from about 6 to about 45 weight percent HFC-152a; from about 6 to about 25 weight percent HFC-152a; from about 6 to about 13 weight percent HFC-152a; from about 13 to about 45 weight percent HFC-152a; from about 13 to about 25 weight percent HFC-152a; or from about 25 to about 45 weight percent HFC-152a.

Addition of HFC-152a to a composition containing HFC-134 and E-HFO-1234ze does increase GWP slightly (when HFC-152a displaces E-1234ze in the composition), but also improves COP for heating and heating capacity, while actually reducing temperature glide in both the evaporator and condenser.

Without further elaboration, it is believed that one skilled in the art can, using the description herein, utilize the present invention to its fullest extent. The following specific embodiments are, therefore, to be construed as merely illustrative, and do not constrain the remainder of the disclosure in any way whatsoever.

### EXAMPLES

### Example 1

Heating performance of mixtures of HFC-134 and HFC-152a is estimated in high temperature heat pump under the following conditions:

| | |
|---|---|
| Temperature of evaporator, ° C. | 40 |
| Temperature of condenser, ° C. | 85 |
| Suction Superheat, K | 0 |
| Subcooling, K | 0 |
| Compressor efficiency, % | 70 |

TABLE 1

| Components | Mass Fraction of components | | | | | | | | |
|---|---|---|---|---|---|---|---|---|---|
| HFC-134 | 0.10 | 0.20 | 0.30 | 0.40 | 0.50 | 0.60 | 0.70 | 0.80 | 0.90 |
| HFC-152a | 0.90 | 0.80 | 0.70 | 0.60 | 0.50 | 0.40 | 0.30 | 0.20 | 0.10 |
| Pcond, MPa | 2.57 | 2.54 | 2.51 | 2.48 | 2.45 | 2.43 | 2.41 | 2.40 | 2.39 |
| COPh | 4.346 | 4.358 | 4.367 | 4.375 | 4.379 | 4.38 | 4.377 | 4.368 | 4.352 |
| CAPh, kJ/m³ | 5,874 | 5,805 | 5,736 | 5,667 | 5,600 | 5,535 | 5,474 | 5,419 | 5,372 |
| GLIDE_cond, K | 0.06 | 0.09 | 0.10 | 0.09 | 0.07 | 0.05 | 0.02 | 0.00 | 0.00 |
| GLDIE_evap, K | 0.07 | 0.11 | 0.12 | 0.11 | 0.09 | 0.06 | 0.03 | 0.01 | 0.00 |

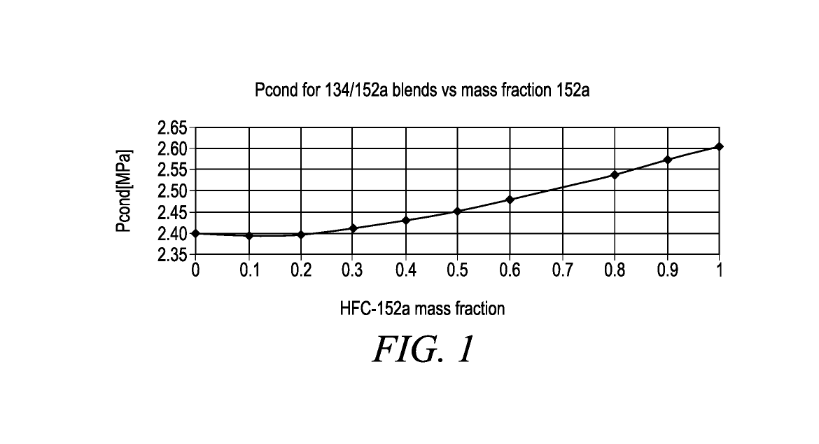

Based on the above results, and extrapolations from the plots of FIGS. 1, 2 and 3 addition of HFC-152a to HFC-134 improves performance in terms of COP (COPh is coefficient of performance for heating, a measure of energy efficiency) and Capacity (CAPh is the volumetric heating capacity for the working fluid). And also reduces GWP, which may be desired depending on regional/country specific regulations. Even with 40 wt % HFC-152a present the temperature glide is a minimum value of 0.05/0.06 K.

Surprisingly, the addition of HFC-152a to HFC-134 increases both COP and capacity, up to about 40 wt % of HFC-152a. A trade-off between COP and capacity is commonly observed as is seen above at higher HFC-152a concentrations.

### Example 2

Heating performance of mixtures of HFC-134, Z-HFO-1234ze and HFC-152a is estimated in high temperature heat pump under the following conditions:

| | |
|---|---|
| Temperature of evaporator, ° C. | 40 |
| Temperature of condenser, ° C. | 85 |
| Suction Superheat, K | 0 |
| Subcooling, K | 0 |
| Compressor efficiency, % | 70 |

The compositions all have 37/63 weight ratio for HFC-134/E-HFO-1234ze and then HFC-152a is added to the mixture at varying amounts.

TABLE 2

| Component | Mass Fraction of components | | | | | | | | | |
|---|---|---|---|---|---|---|---|---|---|---|
| HFO-1234ze-E | 0.063 | 0.126 | 0.189 | 0.252 | 0.315 | 0.378 | 0.441 | 0.504 | 0.567 | 0.63 |
| HFC-134 | 0.037 | 0.074 | 0.111 | 0.148 | 0.185 | 0.222 | 0.259 | 0.296 | 0.333 | 0.37 |
| HFC-152a | 0.9 | 0.8 | 0.7 | 0.6 | 0.5 | 0.4 | 0.3 | 0.2 | 0.1 | 0 |
| Pcond, MPa | 2.58 | 2.56 | 2.54 | 2.52 | 2.49 | 2.47 | 2.44 | 2.42 | 2.39 | 2.37 |
| COPh | 4.322 | 4.309 | 4.294 | 4.277 | 4.257 | 4.233 | 4.205 | 4.172 | 4.132 | 4.085 |
| CAPh, kJ/m³ | 5,862 | 5,778 | 5,689 | 5,595 | 5,495 | 5,389 | 5,277 | 5,156 | 5,027 | 4,888 |
| GLIDE_cond, K | 0.03 | 0.05 | 0.06 | 0.07 | 0.07 | 0.06 | 0.05 | 0.05 | 0.05 | 0.07 |
| GLDIE_evap, K | 0.03 | 0.05 | 0.07 | 0.07 | 0.06 | 0.05 | 0.04 | 0.03 | 0.03 | 0.05 |

Addition of HFC-152a to a composition containing HFC-134 and E-HFO-1234ze does increase GWP slightly (when HFC-152a displaces E-1234ze in the composition), but also improves COP for heating and heating capacity, while actually reducing temperature glide in both the evaporator and condenser.

### Example 3

### Global Warming Potential

Global warming potential (GWP) for HFC-134 can be reduced by addition of certain additional compounds as disclosed herein. Table 3 demonstrates the GWP reduction for several claimed compositions.

TABLE 3

| | GWP (100 yr |
|---|---|
| Compound or Composition (wt %) | time horizon) |
| HFC-134a | 1430 |
| HFC-134 | 1100 |
| HFC-143 | 353 |
| HFC-152 | 53 |
| HFC-152a | 124 |
| HFC-161 | 12 |
| HFC-32 | 675 |
| HCC-40 | 13 |
| HCFC-124 | 609 |
| E-HFO-1234ze | 6 |
| Z-HFO-1225ye | <1 |
| HFO-1225zc | <1 |
| HFC-134/HFC-143 (90/10) | 1025 |
| HFC-134/HFC-143 (80/20) | 951 |
| HFC-134/HFC-143 (85/15) | 988 |
| HFC-134/HFC-143 (50/50) | 727 |
| HFC-134/HFC-152 (90/10) | 995 |
| HFC-134/HFC-152 (80/20) | 1001 |
| HFC-134/HFC-152 (50/50) | 577 |
| HFC-134/HFC-152a (94/6) | 1041 |
| HFC-134/HFC-152a (92/8) | 1022 |
| HFC-134/HFC-152a (90/10) | 1002 |
| HFC-134/HFC-152a (89/11) | 993 |
| HFC-134/HFC-152a (88/12) | 983 |
| HFC-134/HFC-152a (85/15) | 954 |
| HFC-134/HFC-152a (55/45) | 661 |
| HFC-134/HFC-152a (50/50) | 612 |
| HFC-134/HFC-152a (40/60) | 514 |
| HFC-134/HFC-152a (38/62) | 495 |
| HFC-134/HFC-152a (10/90) | 222 |
| HFC-134/HFC-161 (90/10) | 991 |
| HFC-134/HFC-161 (50/50) | 556 |
| HFC-134/HFC-161 (45/55) | 502 |
| HFC-134/HFC-161 (44/56) | 491 |
| HFC-134/HFC-32 (50/50) | 888 |
| HFC-134/HFC-32 (60/40) | 930 |
| HFC-134/HFC-32 (65/35) | 951 |
| HFC-134/HFC-32 (70/30) | 973 |
| HFC-134/HFC-32 (72/28) | 981 |
| HFC-134/HFC-32 (73/27) | 985 |
| HFC-134/HFC-32 (75/25) | 994 |
| HFC-134/HCC-40 (90/10) | 991 |
| HFC-134/HCC-40 (50/50) | 557 |
| HFC-134/HCC-40 (45/55) | 502 |
| HFC-134/HCC-40 (44/56) | 491 |
| HFC-134/HCFC-124 (90/10) | 1051 |
| HFC-134/HCFC-124 (50/50) | 855 |
| HFC-134/HCFC-124 (60/40) | 904 |
| HFC-134/HCFC-124 (70/30) | 953 |
| HFC-134/HCFC-124 (75/25) | 977 |
| HFC-134/HCFC-124 (78/22) | 992 |
| HFC-134/Z-HFO-1234ze (90/10) | 991 |
| HFC-134/Z-HFO-1234ze (50/50) | 553 |
| HFC-134/Z-HFO-1234ze (45/55) | 498 |
| HFC-134/HFC-152a/Z-HFO-1234ze (31/6/63) | 352 |
| HFC-134/HFC-152a/Z-HFO-1234ze (12/25/63) | 167 |
| HFC-134/HFC-152a/Z-HFO-1234ze (40/25/35) | 473 |
| HFC-134/HFC-152a/Z-HFO-1234ze (12/45/43) | 190 |
| HFC-134/HFC-152a/Z-HFO-1234ze (40/13/47) | 459 |
| HFC-134/HFC-152a/1225ye (40/25/35) | 471 |
| HFC-134/HFC-152a/HFO-1225zc (40/13/47) | 456 |
| HFC-134/HFC-134a/HFC-152a/Z-HFO-1225ye | 925 |
| (70/10/10/10) | |
| HFC-134/HFC-152a/Z-HFO-1225ye/HFO- | 746 |
| 1225zc (65/25/5/5) | |
| HFC-134/HFC-152a/Z-HFO-1225ye/HFO- | 1051 |
| 1225zc (95/4.9/0.05/0.05) | |
| HFC-134/HFC-152a/HFC-134a/HFO-1225zc | 1052 |
| (95/4.9/0.05/0.05) | |
| HFC-134/HFC-32/Z-HFO-1225ye/HFO-1225zc | 1078 |
| (95/4.9/0.05/0.05) | |

Many of the compositions of the present invention can be formulated to have GWP less than 1000. Several compositions can be formulated to have GWP less than 500.

### Example 4

### Chiller Performance

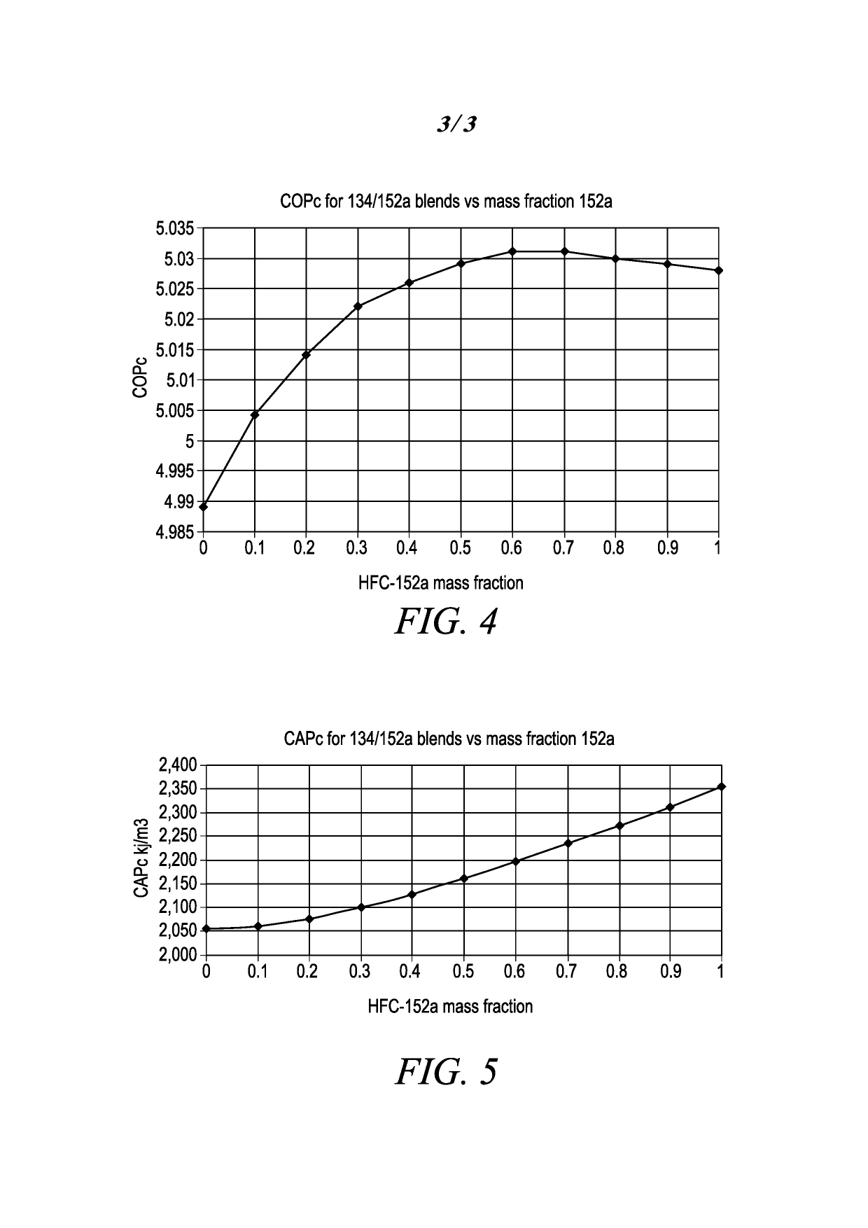

Performance of blends containing HFC-134 and HFC-152a is estimated and shown in Table 4 below. In the table, COPc is the coefficient of performance (a measure of energy efficiency) for cooling. CAPc is the volumetric cooling capacity, Utip is the impeller tip speed for a centrifugal compressor. See also FIGS. 4 and 5, plots of the data from Table 4.

Conditions for which performance is estimated:

| | |
|---|---|
| Temperature of the evaporator, ° C. | 4.44 |
| Temperature of the condenser, ° C. | 37.78 |
| Superheat, K | 0 |
| Subcooling, K | 0 |
| Compressor efficiency, % | 70 |

TABLE 4

| | Neat | | | | | | | | | |
|---|---|---|---|---|---|---|---|---|---|---|
| | HFC- | | | | | | | | | |
| Component | 134a | Mass Fraction for components | | | | | | | | |
| HFC-134 | 0 | 0.9 | 0.8 | 0.7 | 0.6 | 0.5 | 0.4 | 0.3 | 0.2 | 0.1 |
| HFC-152a | 0 | 0.1 | 0.2 | 0.3 | 0.4 | 0.5 | 0.6 | 0.7 | 0.8 | 0.9 |
| HFC-134a | 1 | 0 | 0 | 0 | 0 | 0 | 0 | 0 | 0 | 0 |
| COPc | 4.849 | 5.004 | 5.014 | 5.022 | 5.026 | 5.029 | 5.031 | 5.031 | 5.03 | 5.029 |
| COPc vs | | 3.2 | 3.4 | 3.6 | 3.7 | 3.7 | 3.8 | 3.8 | 3.7 | 3.7 |
| COPc_134a, | | | | | | | | | | |
| % difference | | | | | | | | | | |
| CAPc, kJ/m³ | 2,483 | 2,062 | 2,077 | 2,100 | 2,129 | 2,161 | 2,196 | 2,233 | 2,272 | 2,312 |
| CAPc vs | | −17.0 | −16.3 | −15.4 | −14.3 | −13.0 | −11.6 | −10.1 | −8.5 | −6.9 |
| CAPc_134a, | | | | | | | | | | |
| % | | | | | | | | | | |
| Utip vs | | 5.9 | 8.5 | 11.0 | 13.4 | 15.7 | 17.9 | 20.1 | 22.1 | 24.0 |
| Utip_134a, | | | | | | | | | | |
| % difference | | | | | | | | | | |
| GLIDE_cond, | 0.00 | 0.00 | 0.01 | 0.05 | 0.10 | 0.15 | 0.18 | 0.20 | 0.17 | 0.11 |
| K | | | | | | | | | | |
| GLIDE_evap, | 0.00 | 0.00 | 0.02 | 0.06 | 0.12 | 0.18 | 0.22 | 0.23 | 0.21 | 0.13 |
| K | | | | | | | | | | |

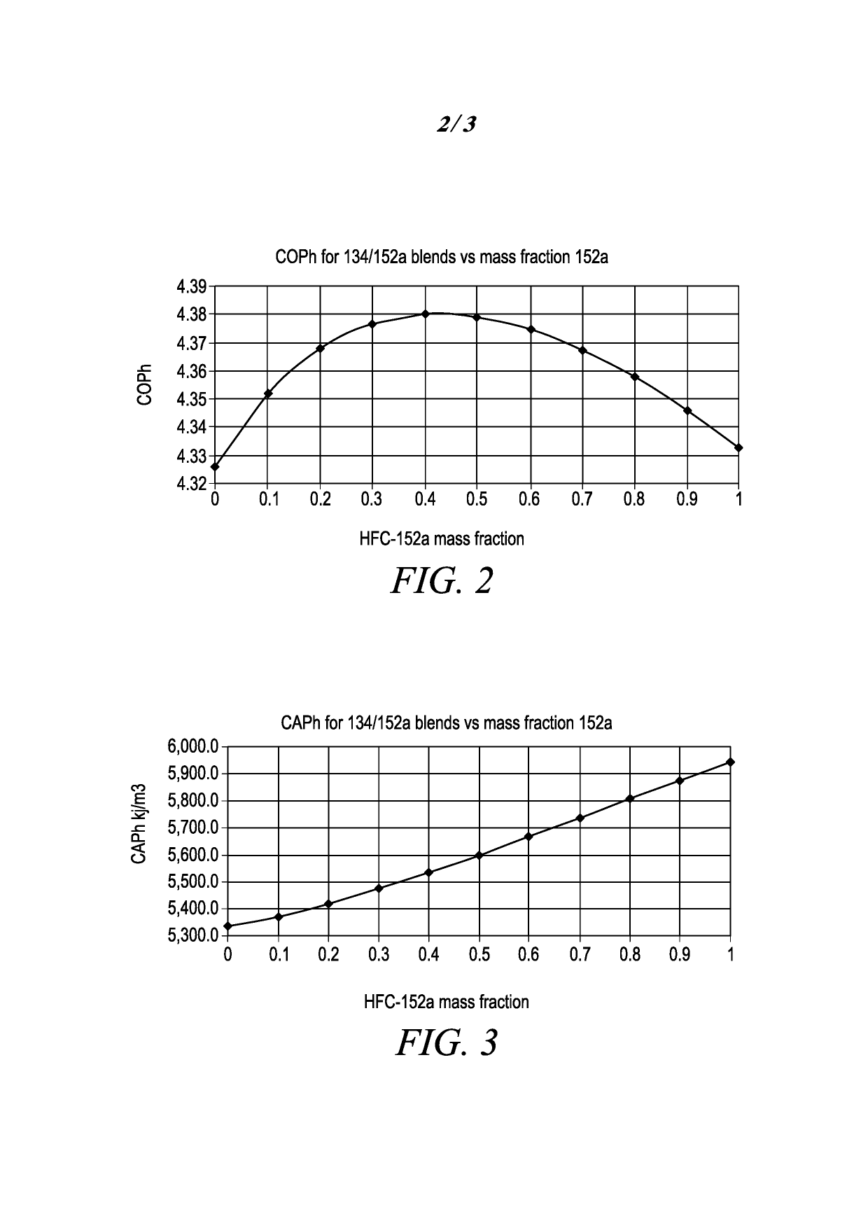

Based on the above results, and extrapolations from the plots of FIG. 2, compositions containing HFC-134 and HFC-152a from about 6-45 wt % HFC-152a provide maximum capacity and COP with glide lower than about 0.15 K and tip speed match to HFC-134a within about 15%.

Surprisingly, the addition of HFC-152a to HFC-134 increases both COP and capacity, usually a trade-off between COP and capacity is observed.

### Example 5

Chillers Operating with HFO-1234Ze(E)/HFC-152a/HFC-134 Blends

Table 5 compares the performance of chillers operated with HFO-1234ze(E)/HFC-152a/HFC-134 blends of various compositions to that with HFC-134a. Conditions for the determination are:

| | |
|---|---|
| Evaporator Temperature: | 4.44° C. |
| Condenser Temperature: | 37.78° C. |
| Superheat: | 0K |
| Subcooling: | 0K |

TABLE 5

| | HFC- | Blend | Blend | Blend | Blend | Blend | Blend |
|---|---|---|---|---|---|---|---|
| | 134a | 1 | 2 | 3 | 4 | 5 | 6 |
| HFO- | 0 | 55 | 50 | 45 | 50 | 45 | 40 |
| 1234ze(E), | | | | | | | |
| wt % | | | | | | | |
| HFC-152a, | 0 | 5 | 10 | 15 | 5 | 10 | 15 |
| wt % | | | | | | | |
| HFC-134, | 0 | 40 | 40 | 40 | 45 | 45 | 45 |
| wt % | | | | | | | |
| HFC-134a, | 100 | 0 | 0 | 0 | 0 | 0 | 0 |
| wt % | | | | | | | |
| GWP | 1300 | 455 | 462 | 469 | 511 | 518 | 525 |
| COPc | 4.849 | 4.921 | 4.934 | 4.947 | 4.926 | 4.940 | 4.953 |
| COPc vs | | 1.4848 | 1.7529 | 2.021 | 1.588 | 1.8767 | 2.1448 |
| COPc_134a, | | | | | | | |
| % difference | | | | | | | |
| CAPc, kJ/m³ | 2,482.7 | 2,042.5 | 2,063.0 | 2,081.8 | 2,051.7 | 2,069.7 | 2,086.2 |
| CAPc vs | | −17.73 | −16.9 | −16.15 | −17.36 | −16.64 | −15.97 |
| CAPc_134a, | | | | | | | |
| % difference | | | | | | | |
| GLIDE_cond, | 0 | 0.04 | 0.03 | 0.02 | 0.02 | 0.01 | 0.01 |
| K | | | | | | | |
| GLIDE_evap, | 0 | 0.02 | 0.02 | 0.02 | 0.01 | 0.01 | 0.02 |
| K | | | | | | | |
| Utip vs | | −0.1 | 1.6 | 3.3 | 0.2 | 2.0 | 3.7 |
| Utip_134a, | | | | | | | |
| % difference | | | | | | | |

All blends have substantially lower GWPs than HFC-134a. They all enable COPs for cooling higher than HFC-134a by about 1.5 to over 2%. They all lead to negligible condenser and evaporator temperature glides that are advantageous for flooded heat exchangers. Finally, the blends in Table 5 would require impeller tip speeds to provide the heat of compression for centrifugal chillers very close (within 3.7%) to the impeller tip speed required with HFC-134a; they would thus allow retrofits from HFC-134a to fluids with lower GWPs with only minor equipment adjustments and improved energy efficiency. At least some of the blends in table are likely to be non-flammable.

### Example 6

Organic Rankine Cycle Operated with HFC-152a/HFC-134 Blends Commonly available power generation equipment is often limited to maximum working pressures lower than about 3 MPa. If HFC-134a is used as the working fluid for an Organic Rankine Cycle, the maximum permissible evaporating temperature would be about 85° C. and the cycle efficiency would be 9.15%, as shown in Table 6a. Replacing HFC-134a with Blend F, while keeping the cycle operating variables constant, would enable a substantial reduction in GWP and an increase in cycle efficiency by 7.1%.

TABLE 6a
ORC performance with HFC-152a/HFC-134 blends compared with
that with HFC-134a at the 85° C. evaporating temperature and close
to the maximum permissible evaporating pressure (3 MPa).

| | HFC-134a | Blend A | Blend E | Blend F |
|---|---|---|---|---|
| HFC-152a, wt % | 0 | 25 | 50 | 80 |
| HFC-134, wt % | 0 | 75 | 50 | 20 |
| HFC-134a, wt % | 100 | 0 | 0 | 0 |
| GWP | 1300 | 875 | 629 | 334 |
| Evaporating Temp, ° C. | 85 | 85 | 85 | 85 |
| Condensing Temp, ° C. | 25 | 25 | 25 | 25 |
| Expander Inlet Superheat, K | 10 | 10 | 10 | 10 |
| Condenser Sub-cooling, K | 0 | 0 | 0 | 0 |
| Expander Efficiency | 0.75 | 0.75 | 0.75 | 0.75 |
| Pump Efficiency | 0.55 | 0.55 | 0.55 | 0.55 |
| Evaporator Pressure, MPa | 2.94 | 2.40 | 2.45 | 2.54 |
| Cycle Thermal Efficiency, % | 9.15 | 9.85 | 9.84 | 9.8 |
| Cycle thermal Efficiency: Blend | | 7.7 | 7.5 | 7.1 |
| vs. HFC-134a, % difference | | | | |

If the available heat source allows operation of the evaporator at 94-95° C., Blends A and E would enable 17.2% and 16.1% higher efficiency, respectively, than with HFC-134a without exceeding the maximum permissible working pressure, as shown in Table 6b. If the available heat source allows operation of the evaporator at 92.5° C., Blend F would enable 14% higher cycle efficiency than with HFC-134a without exceeding the maximum permissible working pressure, as also shown in Table 6b.

TABLE 6b
ORC performance with HFC-152a/HFC-134 blends compared with
that with HFC-134a at the same evaporating pressure (just below the
maximum permissible evaporating pressure of about 3 MPa).

| | HFC-134a | Blend A | Blend E | Blend F |
|---|---|---|---|---|
| HFC-152a, wt % | 0 | 25 | 50 | 80 |
| HFC-134, wt% | 0 | 75 | 50 | 20 |
| HFC-134a, wt % | 100 | 0 | 0 | 0 |
| GWP | 1300 | 875 | 629 | 334 |
| Evaporating Temp, ° C. | 85 | 95 | 94 | 92.5 |
| Condensing Temp, ° C. | 25 | 25 | 25 | 25 |
| Expander Inlet Superheat, K | 10 | 10 | 10 | 10 |
| Condenser Sub-cooling, K | 0 | 0 | 0 | 0 |
| Expander Efficiency | 0.75 | 0.75 | 0.75 | 0.75 |
| Pump Efficiency | 0.55 | 0.55 | 0.55 | 0.55 |
| Evaporator Pressure, MPa | 2.94 | 2.95 | 2.95 | 2.96 |
| Cycle Thermal Efficiency, % | 9.15 | 10.72 | 10.62 | 10.43 |
| Cycle thermal Efficiency: Blend 4 | | 17.2 | 16.1 | 14.0 |
| vs. HFC-134a, % difference | | | | |

### Example 7

### Organic Rankine Cycle Operated with HFO-1234Ze(E)/HFC-152a/HFC-134 Blends

Commonly available power generation equipment is often limited to maximum working pressures lower than about 3 MPa. If HFC-134a is used as the working fluid for an Organic Rankine Cycle, the maximum permissible evaporating temperature would be about 85° C. and the cycle efficiency would be 9.15%, as shown in Table 7.

table 7
ORC performance with an HFO-1234ze(E)/HFC-152a/HFC-134 blend
compared with that with HFC-134a: (a) at the same evaporating
temperature; and (b) at the maximum permissible evaporating pressure
(about 3 MPa).

| | HFC-134a | Blend 4 (a) | Blend 4 (b) |
|---|---|---|---|
| HFO-1234ze(E), wt % | 0 | 50 | 50 |
| HFC-152a, wt % | 0 | 5 | 5 |
| HFC-134, wt % | 0 | 45 | 45 |
| HFC-134a, wt % | 100 | 0 | 0 |
| GWP | 1300 | 511 | 511 |
| Evaporating Temp, ° C. | 85 | 85 | 95 |
| Condensing Temp, ° C. | 25 | 25 | 25 |
| Expander Inlet Superheat, K | 10 | 10 | 10 |
| Condenser Sub-cooling, K | 0 | 0 | 0 |
| Expander Efficiency | 0.75 | 0.75 | 0.75 |
| Pump Efficiency | 0.55 | 0.55 | 0.55 |
| Evaporator Pressure, MPa | 2.94 | 2.40 | 2.94 |
| Cycle Thermal Efficiency, % | 9.15 | 9.56 | 10.36 |
| Cycle thermal Efficiency: Blend 4 vs. | | 4.5 | 13.2 |
| HFC-134a, % difference | | | |

Replacing HFC-134a with Blend 4 would enable a substantial reduction in GWP and an increase in cycle efficiency by 4.5%. Moreover, if the available heat source allows operation of the evaporator at 95° C., Blend 4 would enable 13.2% higher efficiency than with HFC-134a without exceeding the maximum permissible working pressure.

### Selected Embodiments

### Embodiment A1

A composition comprising 1,1,2,2-tetrafluoroethane and at least one additional compound selected from the group consisting of 1,1-difluoroethane, 1,2-difluoroethane, 1,1,1-trifluoroethane, difluoromethane, octafluorocyclobutane, 1,1,1,2,3,4,4,4-octafluoro-2-butene, 1,1,1,2,3,3,3-heptafluoropropane, 1,1,3,3,3-pentafluoropropene, 1,1,1,2,2-pentafluoropropane, 1,2,3,3,3-pentafluoropropene, pentafluoroethane, chlorodifluoromethane, 2-chloro-1,1,1,2-tetrafluoroethane, 1-chloro-1,1,2,2-tetrafluoroethane, methyl chloride, chlorofluoromethane, 1,2-dichloro-1,1,2,2-tetrafluoroethane, 1,1-dichloro-1,2,2,2-tetrafluoroethane, 1,1-difluoroethylene, and 1,1,2-trifluoroethylene and combinations thereof.

### Embodiment A2

The composition of Embodiment A1 further comprising at least one compound selected from the group consisting of 1,3,3,3-tetrafluoropropene, 1,1,2-trifluoroethane, 1,1,1,2-tetrafluoroethane, 1,1,1,2,2,3,3-heptafluoropropane and fluoroethane.

### Embodiment A3

The composition of Embodiment A1 or A2 comprising at least one composition selected from the group consisting of:
1,1,2,2-tetrafluoroethane and 1,1-difluoroethane;
1,1,2,2-tetrafluoroethane, 1,1-difluoroethane, and 1,3,3,3-tetrafluoropropene;
1,1,2,2-tetrafluoroethane, 1,1-difluoroethane, and 1,2,3,3,3-pentafluoropropene;
1,1,2,2-tetrafluoroethane, 1,1-difluoroethane, and 1,1,3,3,3-pentafluoropropene;
1,1,2,2-tetrafluoroethane, 1,1-difluoroethane, and 2-chloro-1,1,1,2-tetrafluoroethane;
1,1,2,2-tetrafluoroethane, 1,1-difluoroethane, and 1-chloro-1,1,2,2-tetrafluoroethane;
1,1,2,2-tetrafluoroethane, 1,1-difluoroethane, and chlorofluoromethane;
1,1,2,2-tetrafluoroethane, fluoroethane, and 1,3,3,3-tetrafluoropropene;
1,1,2,2-tetrafluoroethane, fluoroethane, and 1,2,3,3,3-pentafluoropropene;
1,1,2,2-tetrafluoroethane, fluoroethane, and 1,1,3,3,3-pentafluoropropene;
1,1,2,2-tetrafluoroethane, fluoroethane, and 1-chloro-1,1,2,2-tetrafluoroethane;
1,1,2,2-tetrafluoroethane, fluoroethane, and 2-chloro-1,1,1,2-tetrafluoroethane;
1,1,2,2-tetrafluoroethane, fluoroethane, and chlorofluoromethane; 1,1,2,2-tetrafluoroethane, chlorofluoromethane, and 1,3,3,3-tetrafluoropropene;
1,1,2,2-tetrafluoroethane, chlorofluoromethane, and 1,2,3,3,3-pentafluoropropene;
1,1,2,2-tetrafluoroethane, chlorofluoromethane, and 1,1,3,3,3-pentafluoropropene;
1,1,2,2-tetrafluoroethane, chlorofluoromethane, and 1-chloro-1,1,2,2-tetrafluoroethane;
1,1,2,2-tetrafluoroethane, chlorofluoromethane, and 2-chloro-1,1,1,2-tetrafluoroethane;
1,1,2,2-tetrafluoroethane, 1-chloro-1,1,2,2-tetrafluoroethane, and 2-chloro-1,1,1,2-tetrafluoroethane;
1,1,2,2-tetrafluoroethane, 1-chloro-1,1,2,2-tetrafluoroethane, and 1,3,3,3-tetrafluoropropene;
1,1,2,2-tetrafluoroethane, 1-chloro-1,1,2,2-tetrafluoroethane, and 1,2,3,3,3-pentafluoropropene;
1,1,2,2-tetrafluoroethane, 1-chloro-1,1,2,2-tetrafluoroethane, and 1,1,3,3,3-pentafluoropropene;
1,1,2,2-tetrafluoroethane, 2-chloro-1,1,1,2-tetrafluoroethane, and 1,3,3,3-tetrafluoropropene;
1,1,2,2-tetrafluoroethane, 2-chloro-1,1,1,2-tetrafluoroethane, and 1,2,3,3,3-pentafluoropropene;
1,1,2,2-tetrafluoroethane, 2-chloro-1,1,1,2-tetrafluoroethane, and 1,1,3,3,3-pentafluoropropene;
1,1,2,2-tetrafluoroethane, 1,1-difluoroethane, 1,1,1,2-tetrafluoroethane, and 1,2,3,3,3-pentafluoropropene;
1,1,2,2-tetrafluoroethane, 1,1-difluoroethane, 1,1,1,2-tetrafluoroethane, and 1,1,3,3,3-pentafluoropropene;
1,1,2,2-tetrafluoroethane, 1,1-difluoroethane, 1,1,3,3,3-pentafluoropropene and 1,2,3,3,3-pentafluoropropene;
1,1,2,2-tetrafluoroethane, 1,1,1,2-tetrafluoroethane, 1,1,3,3,3-pentafluoropropene, and 1,2,3,3,3-pentafluoropropene; and
1,1,2,2-tetrafluoroethane, 1,1,1,2-tetrafluoroethane, 1,1-difluoroethane, and 1,3,3,3-tetrafluoropropene.

### Embodiment A4

The composition of any of Embodiments A1-A3 containing less than about 1 weight percent of said additional compound, based on the total weight of the composition.

### Embodiment A5

The composition of any of Embodiments A1-A4 further comprising from about 1 ppm to about 1000 ppm of at least one tracer compound.

### Embodiment A6

The composition of any of Embodiments A1-A5 further comprising HF.

### Embodiment A7

The composition of any of Embodiments A1-A6 that are acid free.

### Embodiment A8

The composition of any of Embodiments A1-A7 wherein 1,3,3,3-tetrafluoropropene is E-1,3,3,3-tetrafluoropropene, Z-1,3,3,3-tetrafluoropropene or combinations thereof.

### Embodiment A9

The composition of any of Embodiments A1-A8 wherein 1,2,3,3,3-pentafluoropropene is E-1,2,3,3,3-pentafluoropropene, Z-1,2,3,3,3-pentafluoropropene, or combinations thereof.

### Embodiment A10

The composition of any of Embodiments A1-A9 comprising from about 1 to about 99 weight percent HFC-134 and from about 99 to about 1 weight percent HFC-152a.

### Embodiment A11

The composition of any of Embodiments A1-A10 comprising from about 10 to about 90 weight percent HFC-134 and from about 90 to about 10 weight percent HFC-152a.

### Embodiment A12

The composition of any of Embodiments A1-A11 comprising from about 20 to about 80 weight percent HFC-134 and from about 80 to about 20 weight percent HFC-152a.

### Embodiment A13

The composition of any of Embodiments A1-A12 comprising from about 30 to about 80 weight percent HFC-134 and from about 70 to about 20 weight percent HFC-152a.

### Embodiment A14

The composition of any of Embodiments A1-A13 comprising from about 55 to about 99 weight percent HFC-134 and from about 45 to about 1 weight percent HFC-152a.

### Embodiment A15

The composition of any of Embodiments A1-A14 comprising from about 55 to about 92 weight percent HFC-134 and from about 45 to about 8 weight percent HFC-152a.

### Embodiment A16

The composition of any of Embodiments A1-A15 comprising from about 87 to about 99 weight percent HFC-134 and from about 13 to about 1 weight percent HFC-152a.

### Embodiment A17

The composition of any of Embodiments A1-A16 comprising from about 90 to about 99 weight percent HFC-134 and from about 10 to about 1 weight percent HFC-152a.

### Embodiment A18

The composition of any of Embodiments A1-A17 comprising from about 55 to about 87 weight percent HFC-134 and from about 45 to about 13 weight percent HFC-152a.

### Embodiment A19

The composition of any of Embodiments A1-A18 comprising from about 70 to about 99 weight percent HFC-134 and from about 30 to about 1 weight percent HFC-152a.

### Embodiment A20

The composition of any of Embodiments A1-A19 comprising from about 20 to about 75 weight percent HFC-134 and from about 80 to about 25 weight percent HFC-152a.

### Embodiment A21

The composition of any of Embodiments A1-A20 comprising from about 50 to about 75 weight percent HFC-134 and from about 50 to about 25 weight percent HFC-152a.

### Embodiment A22

The composition of any of Embodiments A1-A21 comprising from about 20 to about 50 weight percent HFC-134 and from about 80 to about 50 weight percent HFC-152a.

### Embodiment A23

The composition of any of Embodiments A1-A22 comprising from about 1 to about 98 weight percent HFC-134, from about 1 to about 98 weight percent HFC-152a, and from about 1 to about 98 weight percent E-HFO-1234ze.

### Embodiment A24

The composition of any of Embodiments A1-A23 comprising from about 10 to about 80 weight percent HFC-134, from about 10 to about 80 weight percent HFC-152a, and from about 10 to about 80 weight percent E-HFO-1234ze.

### Embodiment A25

The composition of any of Embodiments A1-A24 comprising from about 1 to about 40 weight percent HFC-134, from about 6 to about 45 weight percent HFC-152a, and from about 15 to about 63 weight percent E-HFO-1234ze.

### Embodiment A26

The composition of any of Embodiments A1-A25 comprising from about 12 to about 40 weight percent HFC-134, from about 6 to about 25 weight percent HFC-152a, and from about 18 to about 63 weight percent E-HFO-1234ze.

### Embodiment A27

The composition of any of the preceding claims comprising from about 15 to about 40 weight percent HFC-134, from about 6 to about 13 weight percent HFC-152a, and from about 15 to about 60 weight percent E-HFO-1234ze.

### Embodiment A28

The composition of any of Embodiments A1-A27 comprising from about 24 to about 40 weight percent HFC-134, from about 13 to about 45 weight percent HFC-152a, and from about 18 to about 60 weight percent E-HFO-1234ze.

### Embodiment A29

The composition of any of Embodiments A1-A28 comprising from about 24 to about 37 weight percent HFC-134, from about 13 to about 25 weight percent HFC-152a, and from about 35 to about 63 weight percent E-HFO-1234ze.

### Embodiment A30

The composition of any of Embodiments A1-A29 comprising from about 27 to about 40 weight percent HFC-134, from about 25 to about 45 weight percent HFC-152a, and from about 35 to about 60 weight percent E-HFO-1234ze.

### Embodiment A31

The composition of any of Embodiments A1-A30 comprising from about 4 to about 33 weight percent HFC-134, from about 10 to about 90 weight percent HFC-152a, and from about 6 to about 57 weight percent E-HFO-1234ze.

### Embodiment A32

The composition of any of Embodiments A1-A31 comprising from about 12 to about 40 weight percent HFC-134, from about 6 to about 45 weight percent HFC-152a, and from about 35 to about 63 weight percent E-HFO-1234ze.

### Embodiment A33

The composition of any of Embodiments A1-A32 comprising from about 40 to about 45 weight percent HFC-134, from about 5 to about 15 weight percent HFC-152a, and from about 40 to about 55 weight percent E-HFO-1234ze.

### Embodiment A34

The composition of any of Embodiments A1-A33 comprising from about 47 to about 63 weight percent E-HFO-1234ze.

### Embodiment A35

The composition of any of Embodiments A1-A34 comprising from about 47 to about 60 weight percent E-HFO-1234ze.

### Embodiment A36

The composition of any of Embodiments A1-A35 comprising from about 50 to about 63 weight percent E-HFO-1234ze.

### Embodiment A37

The composition of any of Embodiments A1-A36 comprising from about 50 to about 60 weight percent E-HFO-1234ze.

### Embodiment B1

A method for producing cooling comprising evaporating a composition of any of Embodiments A1-A37 in the vicinity of a body to be cooled, and thereafter condensing said composition.

### Embodiment C1

A method for producing heating comprising condensing a composition of any of Embodiments A1-A37 in the vicinity of a body to be heated, and thereafter evaporating said compositions.

### Embodiment C2

The method for producing heating of Embodiment C1, wherein said heating is produced in a high temperature heat pump comprising a heat exchanger operating temperature of at least 55° C.

### Embodiment C3

The method of any of Embodiment C1-C2 wherein the heat exchanger is selected from the group consisting of a supercritical working fluid cooler and a condenser.

### Embodiment C4

The method of any of Embodiment C1-C3, wherein the heat exchanger operates at a temperature greater than about 71° C.

### Embodiment C5

The method of any of Embodiment C1-C4, wherein the high temperature heat pump further comprises a centrifugal compressor.

### Embodiment D1

A method for producing heating in a high temperature heat pump wherein heat is exchanged between at least two stages arranged in a cascade configuration, comprising:

absorbing heat at a selected lower temperature in a first working fluid in a first cascade stage and transferring this heat to a second working fluid of a second cascade stage that supplies heat at a higher temperature; wherein the first or second working fluid comprises a composition of any of Embodiments A1-A37.

### Embodiment E1

A method for raising the condenser operating temperature in a high temperature heat pump apparatus comprising:

charging the high temperature heat pump with a working fluid comprising a composition of any of Embodiments A1-A37.

### Embodiment F1

A high temperature heat pump apparatus containing a working fluid comprising a composition of any of Embodiments A1-A37.

### Embodiment F2

The high temperature heat pump apparatus of Embodiment F1, wherein said high temperature heat pump comprises a heat exchanger operating at a temperature of at least 55° C.

### Embodiment F3

The method of any of Embodiment F1-F2 wherein the heat exchanger is selected from the group consisting of a supercritical working fluid cooler and a condenser.

### Embodiment F4

The method of any of Embodiment F1-F3, wherein the heat exchanger operates at a temperature greater than about 71° C.

### Embodiment G1

Use of a refrigerant a composition of any of Embodiments A1-A37 as working fluid in a high temperature heat pump.

### Embodiment G2

The use of Embodiment G1, wherein said high temperature heat pump comprises a heat exchanger operating temperature of at least 55° C.

### Embodiment G3

The use of any of Embodiment G1-G2 wherein the heat exchanger is selected from the group consisting of a supercritical working fluid cooler and a condenser.

### Embodiment G4

The use of any of Embodiment G1-G3, wherein the heat exchanger operates at a temperature greater than about 71° C.

### Embodiment H1

A method for replacing HFC-134a in a high temperature heat pump comprising charging said high temperature heat pump with a composition of any of Embodiments A1-A37; wherein said high temperature heat pump comprises a centrifugal compressor.

### Embodiment H2

The method of Embodiment H1, wherein said high temperature heat pump further comprises a heat exchanger operating temperature of at least 55° C.

### Embodiment H3

The method of any of Embodiment H1-H2 wherein the heat exchanger is selected from the group consisting of a supercritical working fluid cooler and a condenser.

### Embodiment H4

The method of any of Embodiment H1-H3, wherein the heat exchanger operates at a temperature greater than about 71° C.

### Embodiment I1

A process for converting heat to mechanical energy comprising heating a working fluid comprising the composition of any of Embodiments A1-A37 and thereafter expanding the heated working fluid.

What is claimed is:

1. A composition comprising 1,1,2,2-tetrafluoroethane and at least one additional compound selected from the group consisting of 1,1-difluoroethane, 1,2-difluoroethane, 1,1,1-trifluoroethane, difluoromethane, octafluorocyclobutane, 1,1,1,2,3,4,4,4-octafluoro-2-butene, 1,1,1,2,3,3,3-heptafluoropropane, 1,1,3,3,3-pentafluoropropene, 1,1,1,2,2-pentafluoropropane, 1,2,3,3,3-pentafluoropropene, pentafluoroethane, chlorodifluoromethane, 2-chloro-1,1,1,2-tetrafluoroethane, 1-chloro-1,1,2,2-tetrafluoroethane, methyl chloride, chlorofluoromethane, 1,2-dichloro-1,1,2,2-tetrafluoroethane, 1,1-dichloro-1,2,2,2-tetrafluoroethane, 1,1-difluoroethylene, and 1,1,2-trifluoroethylene and combinations thereof.

2. The composition of claim 1 further comprising at least one compound selected from the group consisting of 1,3,3,3-tetrafluoropropene, 1,1,2-trifluoroethane, 1,1,1,2-tetrafluoroethane, 1,1,1,2,2,3,3-heptafluoropropane and fluoroethane.

3. The composition of claim 1 comprising at least one composition selected from the group consisting of:
1,1,2,2-tetrafluoroethane and 1,1-difluoroethane;
1,1,2,2-tetrafluoroethane, 1,1-difluoroethane, and 1,3,3,3-tetrafluoropropene;
1,1,2,2-tetrafluoroethane, 1,1-difluoroethane, and 1,2,3,3,3-pentafluoropropene;
1,1,2,2-tetrafluoroethane, 1,1-difluoroethane, and 1,1,3,3,3-pentafluoropropene;
1,1,2,2-tetrafluoroethane, 1,1-difluoroethane, and 2-chloro-1,1,1,2-tetrafluoroethane;
1,1,2,2-tetrafluoroethane, 1,1-difluoroethane, and 1-chloro-1,1,2,2-tetrafluoroethane;
1,1,2,2-tetrafluoroethane, 1,1-difluoroethane, and chlorofluoromethane;
1,1,2,2-tetrafluoroethane, fluoroethane, and 1,3,3,3-tetrafluoropropene;
1,1,2,2-tetrafluoroethane, fluoroethane, and 1,2,3,3,3-pentafluoropropene;
1,1,2,2-tetrafluoroethane, fluoroethane, and 1,1,3,3,3-pentafluoropropene;
1,1,2,2-tetrafluoroethane, fluoroethane, and 1-chloro-1,1,2,2-tetrafluoroethane;
1,1,2,2-tetrafluoroethane, fluoroethane, and 2-chloro-1,1,1,2-tetrafluoroethane;
1,1,2,2-tetrafluoroethane, fluoroethane, and chlorofluoromethane;
1,1,2,2-tetrafluoroethane, chlorofluoromethane, and 1,3,3,3-tetrafluoropropene;
1,1,2,2-tetrafluoroethane, chlorofluoromethane, and 1,2,3,3,3-pentafluoropropene;
1,1,2,2-tetrafluoroethane, chlorofluoromethane, and 1,1,3,3,3-pentafluoropropene;
1,1,2,2-tetrafluoroethane, chlorofluoromethane, and 1-chloro-1,1,2,2-tetrafluoroethane;
1,1,2,2-tetrafluoroethane, chlorofluoromethane, and 2-chloro-1,1,1,2-tetrafluoroethane;
1,1,2,2-tetrafluoroethane, 1-chloro-1,1,2,2-tetrafluoroethane, and 2-chloro-1,1,1,2-tetrafluoroethane;
1,1,2,2-tetrafluoroethane, 1-chloro-1,1,2,2-tetrafluoroethane, and 1,3,3,3-tetrafluoropropene;
1,1,2,2-tetrafluoroethane, 1-chloro-1,1,2,2-tetrafluoroethane, and 1,2,3,3,3-pentafluoropropene;
1,1,2,2-tetrafluoroethane, 1-chloro-1,1,2,2-tetrafluoroethane, and 1,1,3,3,3-pentafluoropropene;
1,1,2,2-tetrafluoroethane, 2-chloro-1,1,1,2-tetrafluoroethane, and 1,3,3,3-tetrafluoropropene;
1,1,2,2-tetrafluoroethane, 2-chloro-1,1,1,2-tetrafluoroethane, and 1,2,3,3,3-pentafluoropropene;
1,1,2,2-tetrafluoroethane, 2-chloro-1,1,1,2-tetrafluoroethane, and 1,1,3,3,3-pentafluoropropene;
1,1,2,2-tetrafluoroethane, 1,1-difluoroethane, 1,1,1,2-tetrafluoroethane, and 1,2,3,3,3-pentafluoropropene;
1,1,2,2-tetrafluoroethane, 1,1-difluoroethane, 1,1,1,2-tetrafluoroethane, and 1,1,3,3,3-pentafluoropropene;
1,1,2,2-tetrafluoroethane, 1,1-difluoroethane, 1,1,3,3,3-pentafluoropropene and 1,2,3,3,3-pentafluoropropene;
1,1,2,2-tetrafluoroethane, 1,1,1,2-tetrafluoroethane, 1,1,3,3,3-pentafluoropropene, and 1,2,3,3,3-pentafluoropropene; and
1,1,2,2-tetrafluoroethane, 1,1,1,2-tetrafluoroethane, 1,1-difluoroethane, and 1,3,3,3-tetrafluoropropene.

4. The composition of claim 1 containing less than about 1 weight percent of said additional compound, based on the total weight of the composition.

5. The composition of claim 1, further comprising from about 1 ppm to about 1000 ppm of at least one tracer compound.

6.-13. (canceled)

14. A method for producing cooling comprising evaporating a composition of claim 1 in the vicinity of a body to be cooled, and thereafter condensing said composition.

15. A method for producing heating comprising condensing a composition of claim 1 in the vicinity of a body to be heated, and thereafter evaporating said compositions.

16. The method for producing heating of claim 15, wherein said heating is produced in a high temperature heat pump comprising a heat exchanger operating temperature of at least 55° C.

17. The method of claim 16 wherein the heat exchanger is selected from the group consisting of a supercritical working fluid cooler and a condenser.

18. The method of claim 16, wherein the heat exchanger operates at a temperature greater than about 71° C.

19. The method of claim 16, wherein the high temperature heat pump further comprises a centrifugal compressor.

20. A method for producing heating in a high temperature heat pump wherein heat is exchanged between at least two stages arranged in a cascade configuration, comprising:
absorbing heat at a selected lower temperature in a first working fluid in a first cascade stage and transferring this heat to a second working fluid of a second cascade stage that supplies heat at a higher temperature; wherein the first or second working fluid comprises a composition of claim 1.

21. A method for raising the condenser operating temperature in a high temperature heat pump apparatus comprising:
charging the high temperature heat pump with a working fluid comprising a composition of claim 1.

22. A high temperature heat pump apparatus containing a working fluid comprising a composition of any of claim 1.

23. (canceled)

24. A method for replacing HFC-134a in a high temperature heat pump comprising charging said high temperature heat pump with a composition of claim 1; wherein said high temperature heat pump comprises a centrifugal compressor.

25. The method of claim 24, wherein the high temperature heat pump also comprises a condenser with operating temperature greater than about 55° C.

25. (canceled)

26. A process for converting heat to mechanical energy comprising heating a working fluid comprising the composition of claim 1 and thereafter expanding the heated working fluid.
